(19) United States
(12) Patent Application Publication
(10) Pub. No.: US 2017/0185936 A1
(43) Pub. Date: Jun. 29, 2017

(54) System and Method for Enhancing and Sustaining Operational Efficiency

(71) Applicant: Diego Guicciardi, San Antonio, TX (US)

(72) Inventor: Diego Guicciardi, San Antonio, TX (US)

(21) Appl. No.: 15/456,772

(22) Filed: Mar. 13, 2017

Related U.S. Application Data
(63) Continuation of application No. 14/961,498, filed on Dec. 7, 2015, now abandoned.
Application No. 14/961,498 is a continuation of application No. 13/370,727, filed on Feb. 10, 2012, now abandoned.
(60) Provisional application No. 61/441,399, filed on Feb. 10, 2011.

(51) Int. Cl. G06Q 10/06

(52) U.S. Cl. CPC G06Q 10/06393; G06Q 10/06312; G06Q 10/0633; G06Q 10/0635; G06Q 10/06395; G06Q 10/063; G06Q 10/0631; G06Q 10/0639

(57) ABSTRACT

The instant specification discloses methods and means for enhancing and sustaining performance efficiencies within an organization, the methods and means including at least an operational methodology and a software package. Using the Methodology with the related software enables an organization to effectively plan, document, manage and continuously improve its operations in order to achieve (and possibly exceed) its business goals. Therefore, the Methodology and the related System enable an organization to safely and efficiently achieve business excellence and sustain it over time.

### BACKGROUND OF THE INVENTION

Previously, no single software package has existed that embodies management principles equally applicable across operational platforms drawn to a process for enhancing operational efficiency. Instead, there have been a limited number of industry-specific programs, which typically rely on outdated and/or unrealistic means for analyzing, creating, deploying, and verifying various efficiency enhancement processes. However, modern business has brought great change to the marketplace, and greatly increased the pace at which substantive change occurs within an industry. When such change occurs, it generally results in abandonment of such prior art efforts, even in instances where the prior art efforts were fully implemented, which is itself quite rare. There is, therefore, a long-felt but unmet need for a single, unified software package that embodies effective, well-founded management principles that are equally applicable across all operational platforms, which is drawn to a process for globally enhancing operational efficiency.

### SUMMARY OF THE INVENTION

The instant specification discloses methods and means for enhancing performance efficiencies, comprising: (1) an operational methodology (hereinafter also referred to as “the Methodology”), and (2) a software package (hereinafter also referred to as “the System”). The System implements the principles of the Methodology, and enables any user to apply the principles of the Methodology in practice.

According to one example embodiment, a system for enhancing and sustaining operational efficiency is disclosed, wherein the system includes at least a processor disposed in communication with a software package, with the software package further including at least a means for clarifying business goals and success factors; means for identifying results indicators; and means for documenting related organizational units, business functions, and business processes. A wide variety of means for identifying, evaluating and mitigating risk and performance factors within an organization are also disclosed.

### BRIEF DESCRIPTION OF THE SEVERAL VIEWS OF THE DRAWING

FIG. 1 is a Knowledge Power Unit (KPU) interface according to a first example embodiment.

FIG. 2 is an Activity Assessment interface according to a second example embodiment.

FIG. 3 is a Technology Assessment interface according to a third example embodiment.

FIG. 4 is a Workplace Assessment interface according to a fourth example embodiment.

FIG. 5 is an Operational Summary: Synthesis Report interface according to a fifth example embodiment.

FIG. 6 is an Operational Summary: Business Goals Report interface according to a sixth example embodiment.

FIG. 7 is an Operational Risk Summary: Indicators Report interface according to a seventh example embodiment.

FIG. 8 is an Operational Summary: Activities Report interface according to an eighth example embodiment.

FIG. 9 is an Operational Summary: Roles Report interface according to a ninth example embodiment.

FIG. 10 is an Operational Summary: Risks Report interface according to a tenth example embodiment.

FIG. 11 is an Operational Summary: Actions Report interface according to an eleventh example embodiment.

FIG. 12 is an Operational Summary: Monitoring Report interface according to a twelfth example embodiment.

FIG. 13 is an Operational Summary: Governance Report interface according to a thirteenth example embodiment.

FIG. 14 is an Operational Summary: Other Process Items Report interface according to a fourteenth example embodiment.

FIG. 15 is a How to Manage Personal Goals in the System interface according to a fifteenth example embodiment.

FIG. 16 is a How to Manage Personal Goals in the System interface according to a sixteenth example embodiment.

FIG. 17 is a How to Manage Personal Goals in the System interface according to a seventeenth example embodiment.

FIG. 18 is a FACTS Based Mind Map interface according to an eighteenth example embodiment.

FIG. 19 is a Link Facts to Mind Map Procedure interface according to a nineteenth example embodiment.

FIG. 20 is a System Smart-Shape Example interface according to a twentieth example embodiment.

FIG. 21 is a Risk Identification Report interface according to a twenty-first example embodiment.

FIG. 22 is a Control Actions Report interface according to a twenty-second example embodiment.

FIG. 23 is an Using Smart-Shapes interface according to a twenty-third example embodiment.

FIG. 24 is an Activity-to-Activity Link Properties interface according to a twenty-fourth example embodiment.

FIG. 25 is an Activity Properties: Execution Parameters interface according to a twenty-fifth example embodiment.

FIG. 26 is an Activities Report (Perform Mode) interface according to a twenty-sixth example embodiment.

FIG. 27 is an Activities Report (Perform Mode) interface according to a twenty-seventh example embodiment.

FIG. 28 is a Lesson Learned's Properties: Summary Section interface according to a twenty-eighth example embodiment.

FIG. 29 is a Lesson Learned's Properties: Description Section interface according to a twenty-ninth example embodiment.

FIG. 30 is an Activity Properties: Cost Parameters interface according to a thirtieth example embodiment.

FIG. 31 is a System Document Properties interface according to a thirty-first example embodiment.

FIG. 32 is a System Document Properties interface according to a thirty-second example embodiment.

FIG. 33 is a System Documents Report interface according to a thirty-third example embodiment.

FIG. 34 is a System Documents Report: Deliverables Section interface according to a thirty-fourth example embodiment.

FIG. 35 is a Visual Project Management interface according to a thirty-fifth example embodiment.

FIG. 36 is a Visual Project Management interface according to a thirty-sixth example embodiment.

FIG. 37 is a Visual Project Management interface according to a thirty-seventh example embodiment.

FIG. 38 is a Visual Project Management interface according to a thirty-eighth example embodiment.

FIG. 39 is a Visual Project Management interface according to a thirty-ninth example embodiment.

FIG. 40 is a Visual Project Management interface according to a fortieth example embodiment.

FIG. 41 is a Visual Project Management interface according to a forty-first example embodiment.

FIG. 42 is a Visual Project Management interface according to a forty-second example embodiment.

FIG. 43 is a Visual Project Management interface according to a forty-third example embodiment.

FIG. 44 is a Logical Association Between KPU and Emails/Reminders/Tasks interface according to a forty-fourth example embodiment.

FIG. 45 is a KPU Centric Search interface according to a forty-fifth example embodiment.

FIG. 46 is a KPU Centric Search interface according to a forty-sixth example embodiment.

FIG. 47 is a KPU Centric Search interface according to a forty-seventh example embodiment.

FIG. 48 is a KPU Centric Search interface according to a forty-eighth example embodiment.

FIG. 49 is a KPU Centric Search interface according to a forty-ninth example embodiment.

### DETAILED DESCRIPTION OF SEVERAL EXAMPLE EMBODIMENTS

Using the Methodology with the related software enables an organization to effectively plan, document, manage, and continuously improve its operations in order to achieve (and possibly exceed) its business goals. Therefore, the Methodology and the related System enable an organization to achieve business excellence and sustain it over time.

### The Methodology

The Methodology systematically translates goals into measurable indicators and uses the impact on these indicators to quantify the value of change and prioritize initiatives. Additionally, the Methodology helps to reward and recognize people within an organization based on measured results, as well as individual and group contributions to excellence and continuous improvement.

The Methodology is designed to systematically take into account the “human element” in every aspect of the business, and involve, empower, inspire, and motivate the people at all levels of the organization. At the same time, it assures that the right processes and infrastructure are in place, and the necessary governance and management oversight is in place to lead to success.

In one example embodiment, the Methodology is a project-based approach consisting of six main phases: (1) Focus; (2) Document; (3) Control; (4) Communicate; (5) Perform; and (6) Reward. Once the first cycle is completed, a new cycle begins in order to assure continuous improvement.

In the Focus phase, management's Business Goals and Critical Success Factors are clarified, results indicators are identified, and the related organizational units, business functions, and business processes to be documented (and possibly improved) are selected using a robust mechanism based on their connection with executive strategies.

In the Document phase, tools are applied to develop and properly document high quality business processes and to refine the measurement system. Properly documented processes should assure clarity of roles and responsibilities, provide people with all necessary data and knowledge, and establish a common operating language to facilitate knowledge sharing and reuse.

In the Control phase, tools are applied to compare “current” versus “desired” performance for a given process, organizational units, or even the entire organization. Subsequently, the “as is” process is analyzed, and critical risks (i.e., those risks, existing or potential, with the highest impact on desired results) are identified and documented. The Methodology classifies operational risk in at least four major categories: (a) People, (b) Activities, (c) Technologies, and (d) Workplaces. These categories help to isolate and control risks to the Business Goal or Activity.

In the Communicate phase, the Methodology team, working hand-in-hand with a “Governance Team,” assures that change is properly communicated to all interested parties so as to ensure a smooth transition.

In the Perform phase, the process is executed by the organization according to all excellence criteria. Known risks as well as new ones are carefully monitored and prompt actions are taken in response to them.

Finally, in the Reward phase, tools are applied by the governance structure to review the process, and “actual” versus “target” results are compared. The governance structure assures that, based on results, people are properly rewarded and recognized.

At this point, the excellence cycle begins again with the validation and/or update of strategic goals along with their respective key results indicators. The process, the people and the infrastructure are reviewed to reflect any changes in the internal or external environment. After the first cycle, the following cycles are incremental and usually require significantly less time and effort to complete.

This process is designed to be “modular” and “scalable”. “Modular” means that each organization can decide which components of the methodology to implement. “Scalable” means that an organization can start with implementing the Methodology on a single process and easily scale it up to many processes. In fact, thanks to the simplicity and clarity of the Methodology and an associated easy-to-use and intuitive software package, the process can be applied to an entire organization, regardless of size, or instead to only desired subcomponents defined within the larger organizational structure.

Since within the Methodology, an Organizational Unit is modeled as a Business Process, this procedure can be equally used to achieve strategic operational alignment within either an Organizational Unit or a Business Process. The System allows the user to prioritize goals, assess risks of failure, and combat those risks using a simple, numerical system or the like. The System also allows a user to see which activities are necessary for fulfillment of a goal, and who within an organization is responsible for those activities.

Through this collaborative and data-driven approach, the entire organization is systematically steered (from the top down) toward achieving shared business goals. Continuous improvement is embedded in even every-day processes, and every business decision is systematically weighed against the business goals that decision is supposed to contribute to achieve.

Within this framework, the right people within the organization are far more likely to take responsibility for predefined Business Goals. Furthermore, cross-functional collaboration among independent organizational units is assured, which is a key requisite for short- and long-term success.

Implementation of the Methodology therefore leads to: (1) achieving balanced results; (2) adding value for customers; (3) leading with vision, inspiration, and integrity; (4) managing by processes; (5) succeeding through people; (6) nurturing creativity and innovation; (7) building partnerships; and (8) taking responsibility for a sustainable future.

According to another example embodiment, a Methodology cycle starts with the definition of management's Business Goals and Critical Success Factors, which are then systematically translated into a well-defined and well documented set of measurable, balanced “result indicators.” Such indicators help monitor progress against the business's vision, mission, and strategy.

In the Methodology, “key results indicators” differ from the “key performance indicators.” For example, the latter carry information that should be frequently monitored by management in order to continuously steer an organization in the desired direction based on those indicators' behavior. A powerful proprietary mechanism within the Methodology is applied to identify, monitor, and control both “key results” and “key performance” indicators, thereby enabling leaders to make more effective and timely decisions.

Regardless of whether customers are external or internal to an organization, the Methodology assures that operational risks affecting customers are systematically and proactively mitigated, and that potential opportunities for improvement and innovation are seized. This approach dramatically helps an organization uncover new ideas from its customer-facing frontlines.

Likewise, the Methodology helps develop business processes that assure closer collaboration with customers while defining or delivering products and services. Furthermore, by adopting a unique approach to value quantification, the Methodology makes sure that every key management decision or action is attached to a well-defined business argument that takes into account not only the value delivered to customers, but also the value delivered to all other stakeholders involved in the transaction.

In one example embodiment, the Methodology cycle starts with the definition of a Governance Team headed by a “Sponsor” in charge of providing the necessary leadership to the initiative. Tools are applied to help the sponsor clarify his or her vision, and to translate it into tangible, measurable, and realistic goals for the organization. In larger, cross-functional Methodology initiatives, “Sponsors” can be assisted by a “Steering Committee” of senior managers. In this process, values are defined and documented, and “respect for values” is measured and monitored across business processes according to a proprietary, extended, balanced scorecard model.

The Methodology rapidly aligns people, activities, technologies, and workplaces to support the continuous achievement of balanced and measurable results. Tools are applied to assure that relevant decisions are always taken based on documented facts and data, and that the impact on strategic business goals is always considered while making these decisions.

In short, the philosophy underlying the Methodology is aimed at valuing people by applying a set of well-defined and highly effective tools that assure that people are fully empowered, inspired, and properly motivated to excel. This is achieved using a rigorous risk-based approach that pays special attention to the activities that people perform, the clarity and meaning of roles and responsibilities, the adequacy of the technology that people use, and the quality of the workplace where people spend their time.

### The System

In one example embodiment, an important element of the System is the Knowledge Power Unit (hereinafter referred to as “KPU”). A KPU is an organized set of well-defined data that can be visually documented, organized, analyzed, archived and distributed, and used and reused via the System. The System also allows users to search and find information within a KPU and across multiple KPUs.

A KPU can be used, for example, to visually describe, document, and manage business operations (along with the related information and knowledge) in accordance with the principles of the Methodology and its related Methodology Cycle. Further, a KPU can be used to visually define, document, prepare, manage/execute, and continuously improve an organizational unit (up to an entire organization) or a business process (or a group of business processes).

The information contained in a KPU can be stored by the System in a database (for example a relational data base) or can be saved in any archival format, including in a file such as an XML file or in database records. The System allows a user to access, visualize, modify, and archive the infatuation related to any given KPU both “locally” (in this case the KPU is stored locally on a user's computer) or “remotely” via a network such as the internet or an intranet (in this example the KPU is stored on a remote server), and then accessed via a dedicated client or a web browser. Further, the System allows multiple connected users to concurrently read-write data from the same KPU, and to modify different parts of the same KPU at the same time. It also provides users with a permissions-based synchronization mechanism that allows users to check out specific parts of a KPU, which they are allowed to edit and to automatically update the server once complete as well as to automatically download the most recent version of KPU data they are allowed to view within the System.

A KPU contains operational information that includes activities and related workflows, as well as any other business related type of knowledge. Using this unique body of valuable, structured, and well thought-out information about an organization, users can more effectively plan strategically, define business goals, and assess and control operational risks undermining the achievement of these goals. Furthermore, a KPU can be used to execute an organization's business process according to all the predefined criteria.

Information contained within a KPU can be logically represented as a tree structure: the top tree node represents the KPU itself (i.e., the overall information container for a certain subject or business context), while the child nodes represent information logically contained within the KPU. The child nodes of the KPU tree are called KPU logical entities.

These logical entities can themselves have progeny, i.e., other child nodes. Each tree node is associated with information or properties of the KPU logical entity. Some examples of a KPU logical entity include a Governance Team, a Business Goal, an Indicator, a Person, a Role, an Activity, and the like.

KPU logical entities can be related to each other in unique and original ways through a set of logical links. For example, some logical links are created automatically by the System (following the principles of the Methodology) and based on the information entered by a user; others are created manually by a user.

In another example embodiment, a user can visually create, consume, modify, archive, and search KPUs and their related body of information and knowledge. The System provides a user with the means to perform these activities via a simple user interface.

Additionally, a user can interact with a KPU through any electronic device provided with a visual display including PDAs, Tablet PCs, Network Computers, Laptops, Desktops, and Workstations. In fact, a user can interact with a KPU via a web browser, a dedicated stand-alone application running on the user's computing device, a client-server application, and the like.

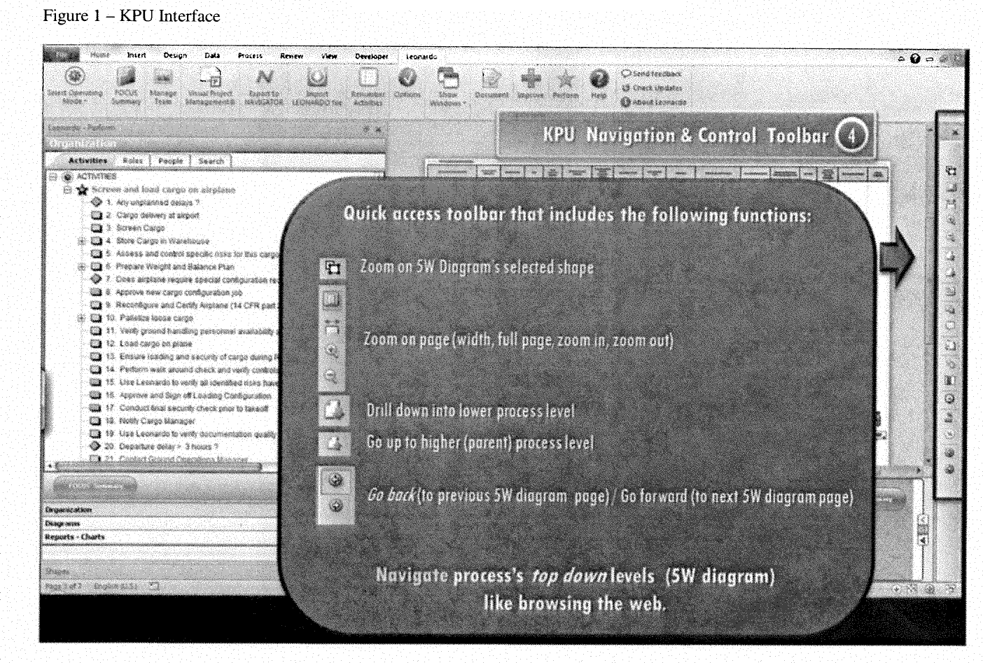

Depending on the particular requirements of the end users, the System can provide different types of user interfaces with different sets of functionalities. (See, e.g., FIG. 1).

In various other embodiments, the System can operate in different “modes” in order to enable a user to implement each step of the Methodology, including Document Mode, Improve Mode, and Perform Mode. These modes can be easily switched and help the user to achieve any Business Goal it may wish.

In some embodiments, the Diagrams and Graphics Area of a KPU is where a user can visually document, using any type of diagrams, any type of information. Such visual diagrams (and the shapes and images within them) are linked to a unique set of data also contained in the KPU and made accessible to the user by the System via its user interface. The KPU Diagrams and Graphics Area can contain any type and any number of diagrams.

The System uses different methods to organize and display child diagrams within a parent diagram. For example, each diagram can be displayed in a different tab and a user can easily switch between tabs to display the desired diagram.

In a presently contemplated embodiment, the System enables definition of Smart Shapes. Within the System, a Smart Shape is a shape with specific properties, also stored in the KPU. Such properties can be visualized by the user via the user interface provided by the System.

By associating graphical shapes with specific information, the System enables a user to create a complete and unique description of who within an organization is charged with each task, as well as how, why, when, and where such tasks are carried out. In other words, such diagrams allow easy creation of documentation showing which people-function roles perform which activities using which technologies in which workplaces.

Within a parent diagram, both technology and workplaces become active roles. In fact, technologies and workplaces can be related to people responsible for them. For instance, a technology can be associated with the people responsible for purchasing, training, and maintenance.

Within a parent diagram, there are different types of roles, each with its own properties contained in the KPU. These role types might include, for example: (1) “people-function” roles, (2) “technology” roles, and (3) “workplace” roles (or simply “place” roles).

According to various embodiments, people-function roles might represent “people” or “business functions.” This type of role can be for groups of people (e.g., Customers, Employees, Suppliers, Teams, etc.), business functions (e.g., Sales or Marketing), or job titles (e.g., Bid Manager, Network Engineers, Vice President, etc.). Technology roles might represent technologies and materials used by the organization and are described in the KPU. Workplace roles might represent locations where the people involved in the organization perform the activities included in the process.

The System enables even less experienced users to develop high quality activity-process diagrams and assures that, within the organization, activities and processes are properly defined. This is done with a simple drag and drop function that automatically adds fields to be filled by the user.

A typical characteristic of a parent diagram is the top down structure used to organize the activities involved in the process. The activities are associated with levels. At the top level are the core activities performed in the process. These activities can be further broken down into sub-activities. The top-down structure of the process is visually translated by the System in a sequence of interlinked process diagrams, each associated with a given level, starting from the top. Each process diagram is logically connected to the levels above and below, and can be easily navigated by the users via the System's user interface.

The System utilizes a visual representation of activities in its “smart shapes.” These smart shapes are also logically linked within the KPU to a specific set of information/knowledge that can be called “Properties.” They are fully customizable by the user to accurately and quickly convey information necessary to the project or activity.

In a parent diagram, activities are visually assigned to roles using lanes. Once an activity has been assigned to one or multiple roles, the activity shape will occupy one or more lanes in which the “Prospecting” activity, for example, is visually assigned to the “Sales Team” role and to the “Customer” role.

The System enables a user to further visually specify a given role that is involved in the desired activity as well as which individuals are responsible for an activity and which business goals such activity contributes to achieve. By allowing users to clearly map activities within the System and to link such activities to their respective responsible people and to a selected list of business goals, the System is able to then automatically combine such information in order to provide a user with a well-constructed and easy to use list of suggested responsible-people for each business goal. The System implements a mechanism presently named LACTI, which stands for Leads, Approves, Consulted, Tasked, and Informed. A user can select multiple LACTI attributes for the same role. Such attributes will be visually displayed by the System in the parent diagram using, for example, a letter symbol.

The System allows a user to drag a lane and change its order within the parent diagram. In such case, the System moves all the shapes contained in that lane along with the lane itself, minimizing the amount of work required to a user to adjust the shapes in the diagram.

Within the parent Diagram, activities can be visually connected to each other by another type of smart shape known as a “smart connector.” The user can specify the type of relationship between activities by selecting the “smart connector” and entering the desired data.

The KPU Management Area enables a user to manage and control the information contained in a KPU. For example, in this area a user can manage the Organization described in the KPU and in particular, the Activities, Roles, People, Diagrams, and Reports associated with the various types of information contained in the KPU.

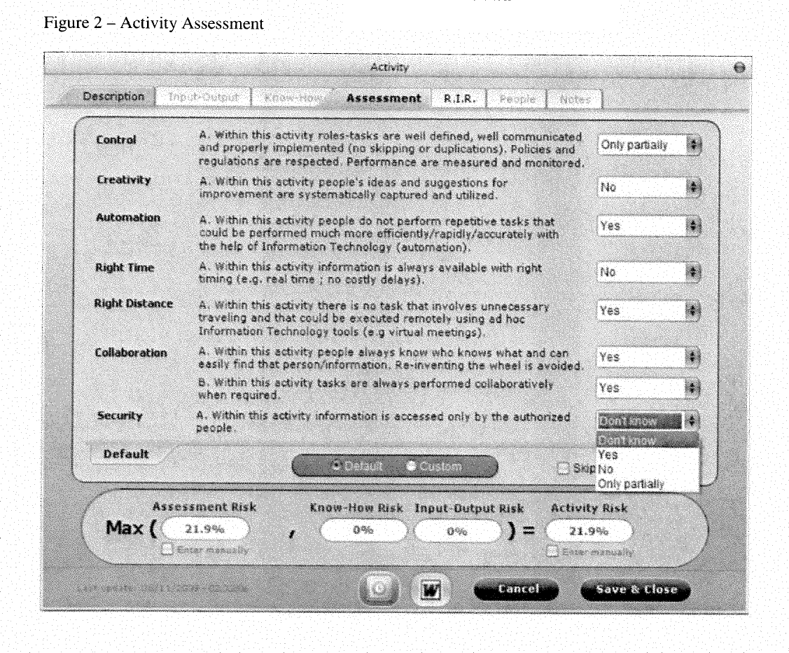

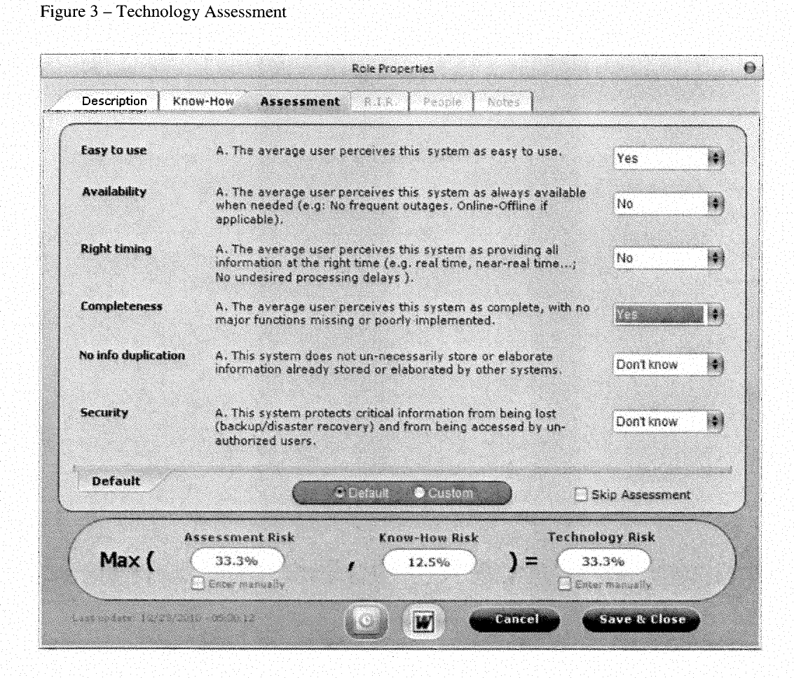

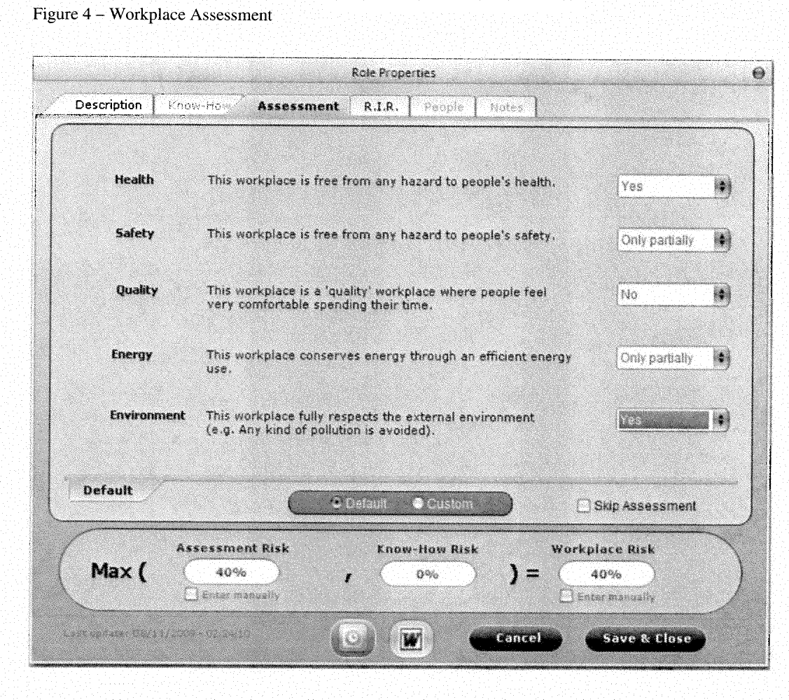

In the System, a risk is always associated with a well defined operational context. The context is the activity, role, or generic item that is affected by the risk which the System helps to uncover using various tools including a pre-defined set of risk assessments. (See, e.g., FIGS. 2, 3, and 4). The risks are assigned values based on the impact they may have on the activity or role or generic item. For example, the risks may be critical, high, normal, or low, depending on their impact. Once a risk has been uncovered, it can be further documented in the System by creating a Risk Identification Report. Within Risk Identification Reports, risks are then assigned a number value to help determine which of the risks should take priority. This “impact” value is taken in the context of the frequency or probability of the risk and is applied to the Indicators discussed above to determine if any change in the indicator should occur. The System will then automatically calculate the priority of the risk based on the importance of the context the risk originates from, the frequency or probability of the risk, and the risk's impact on Business Goals. In various embodiments, one can use the System to review the list of all risks in a single report.

Control Actions, those actions used to combat risks, undergo a similar process to risk determination in order to find their priority to the success of the Business Goal. Aspects considered include the difficulty of implementing the action and any expected resistance to change as a result of the action.

Using the System, a user is able to identify risks for roles of people and functions by assigning measurable values to aspects of an employee. For instance, an employee's current skill level can be compared to the skill needed for that assignment and to the skill's importance in the execution of that assignment. A user can also assess the risk for the role of Technology and Workplaces in the same way. The System will then document the risks by creating a Risk Identification Report. The System will then break down the risk into Impact, Details, Status, Classification, who identified the risk, and other subfields to give an accurate picture of possible risks to the related Business Goals.

The System facilitates the making of Control Action Documentation for those actions taken to combat risks. This document includes the experts who identified the Control Action needed to combat the risk so that the expert may be justly rewarded and consulted. More importantly, it will allow a user to estimate the effort needed to complete the action by measuring the implementation difficulty and expected resistance to change. Using these measurables, a user can use the System to develop an adequate Change Management Plan to enable the business to more easily navigate around the risk and accept a new plan.

A monitoring procedure can be implemented to show: (1) periodic evaluation and testing of controls by internal audit; (2) continuous monitoring programs built into information systems; (3) analysis of, and appropriate follow-up on, operating reports or metrics that might identify anomalies indicative of a control failure; (4) supervisory reviews of controls, such as reconciliation reviews as a normal part of processing; (5) self-assessments by boards and management regarding the tone they set in the organization and the effectiveness of their oversight functions; and (6) audit committee inquiries of internal and external auditors, and quality assurance reviews of the internal audit department. In this way, the System helps to ensure the Control Action is performed and properly mitigates the risk.

Using the System, managers are required to document new operational risks identified by the managers or signaled by their reports and to continuously monitor existing ones throughout the year. Together, managers and their staff are required to timely identify risk related control actions. Using the Control Action's Priority Calculation Procedure, managers can properly prioritize actions and decide whether or not to implement these actions based on the related business case that has been documented using the System.

Within the Methodology Framework, managers, before assigning Personal Goals to their team, are required to assess the operational risks linked to their team Business Goals. Subsequently, managers are required to take personal responsibilities of any control action into account when assigning Personal Goals to their team members. In other words, operational risk management becomes an integral part of the employee's overall performance evaluation cycle, where, throughout the agreed evaluation time frame, Personal Goals might include taking care of relevant operational risks that have emerged, and making sure that new risks are signaled to management and collaboratively mitigated in a timely fashion.

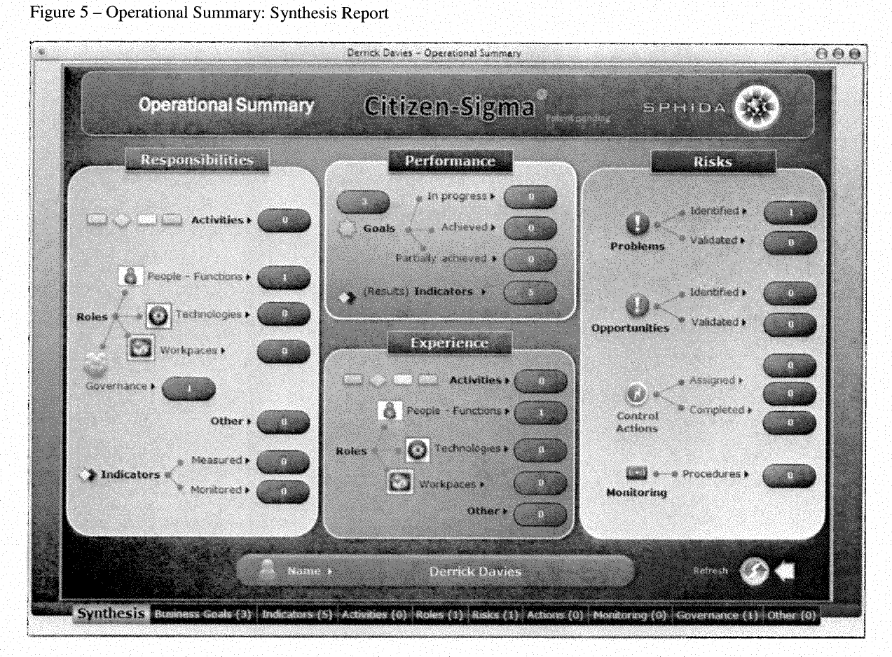

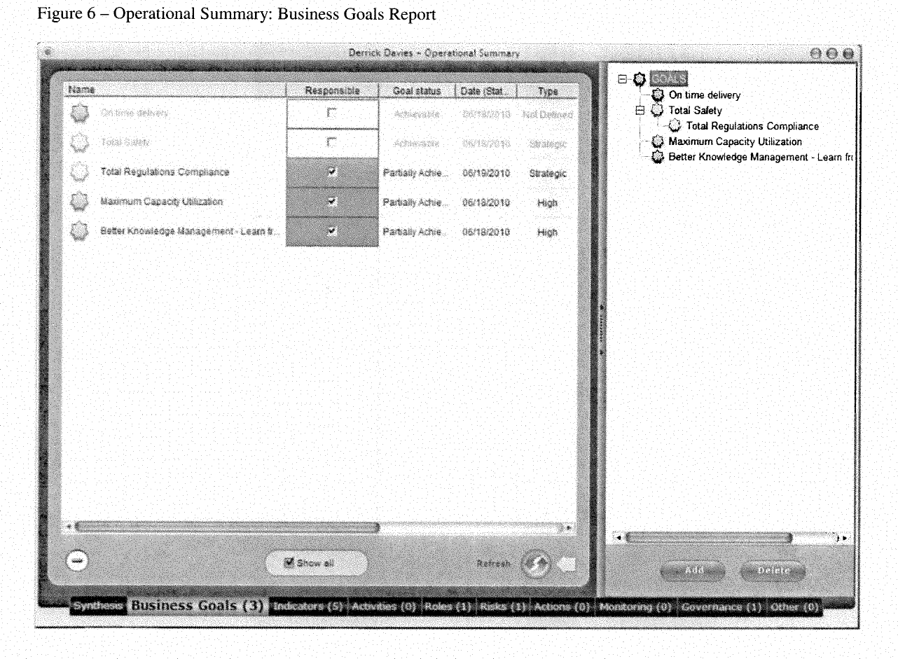

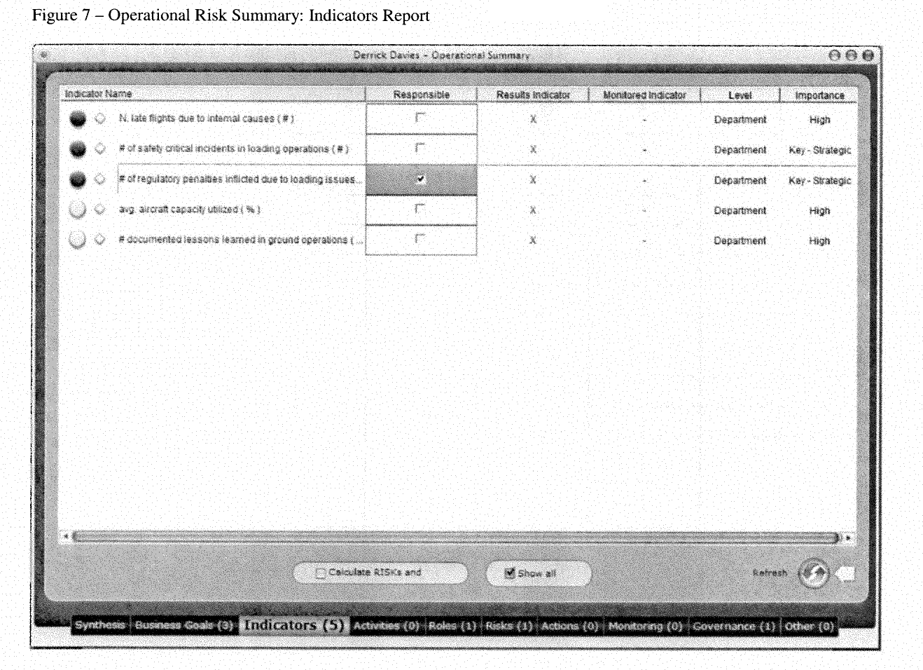

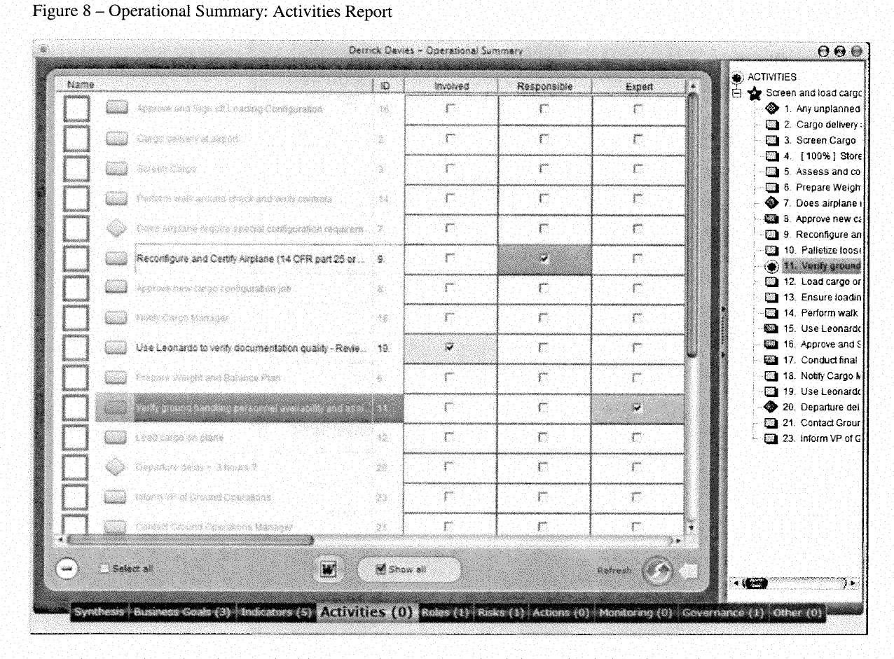

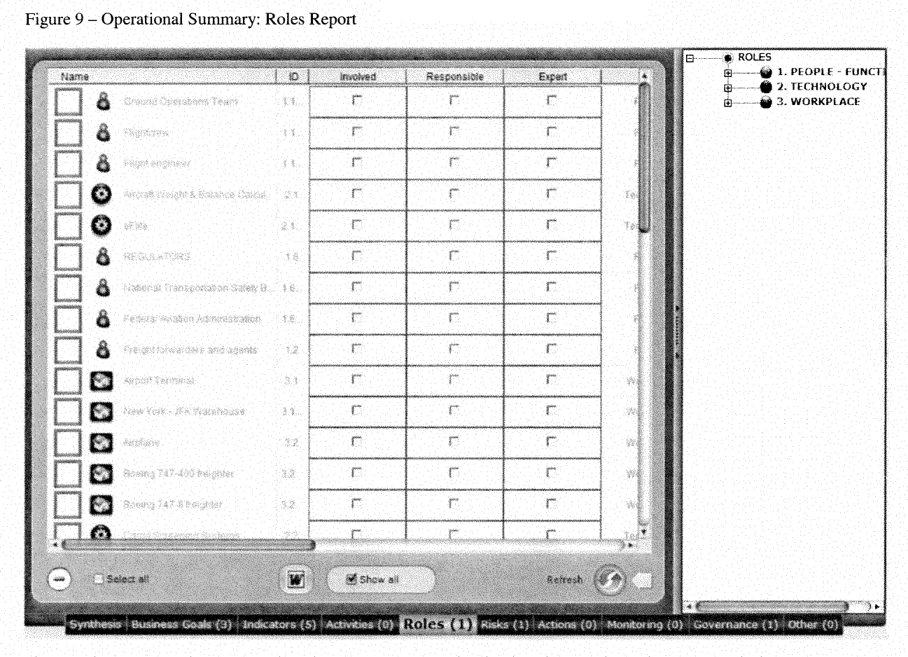

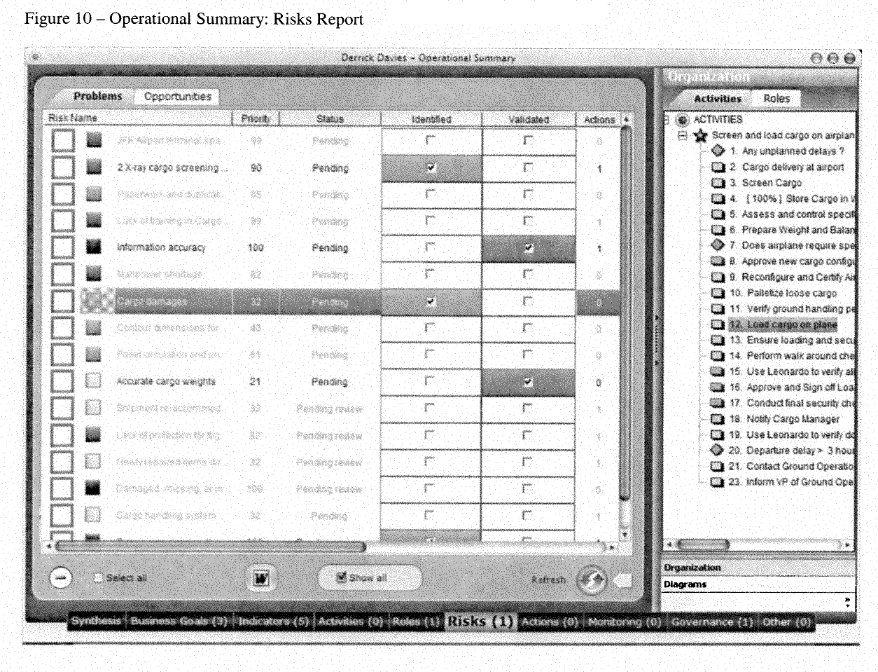

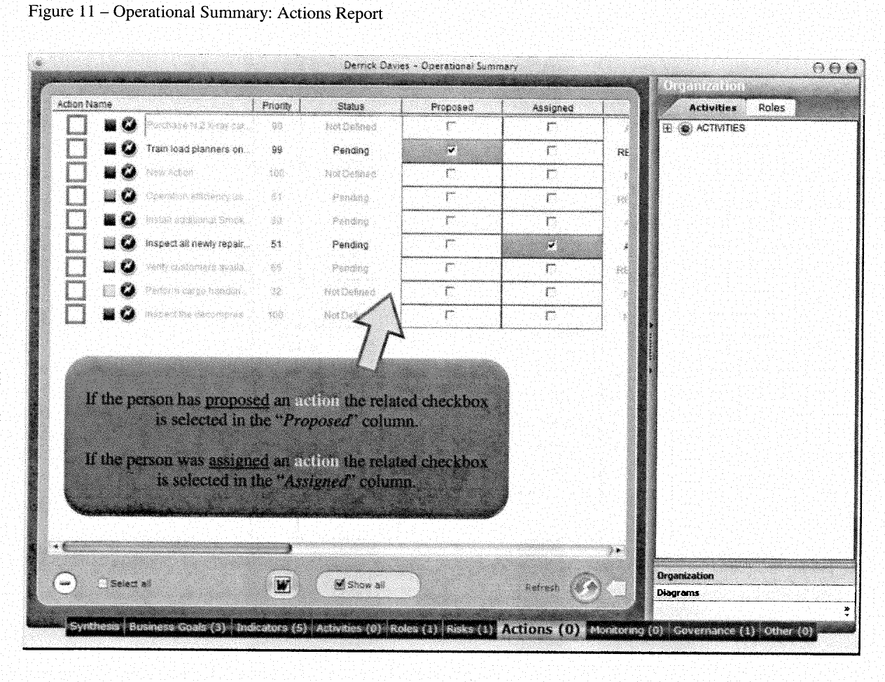

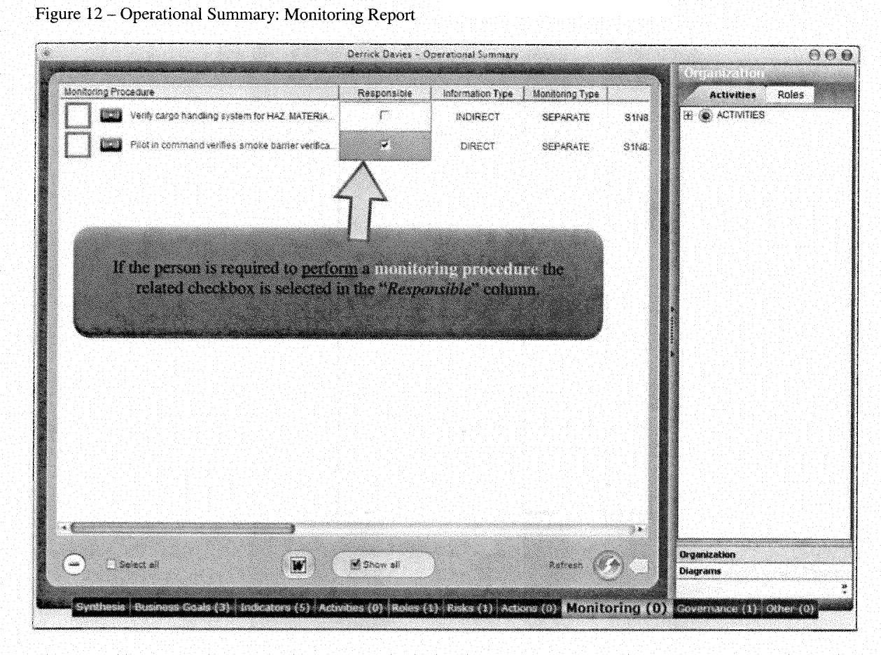

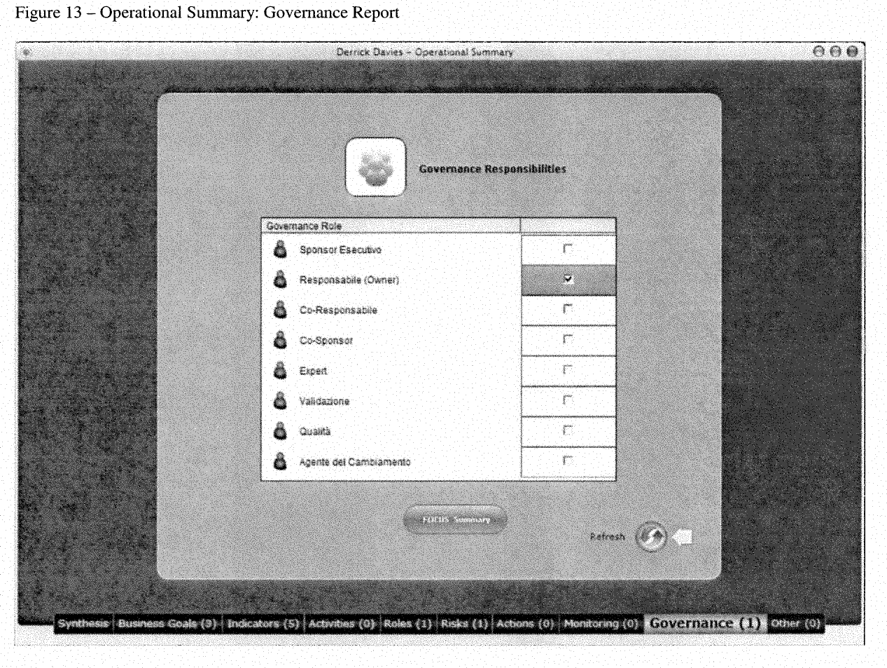

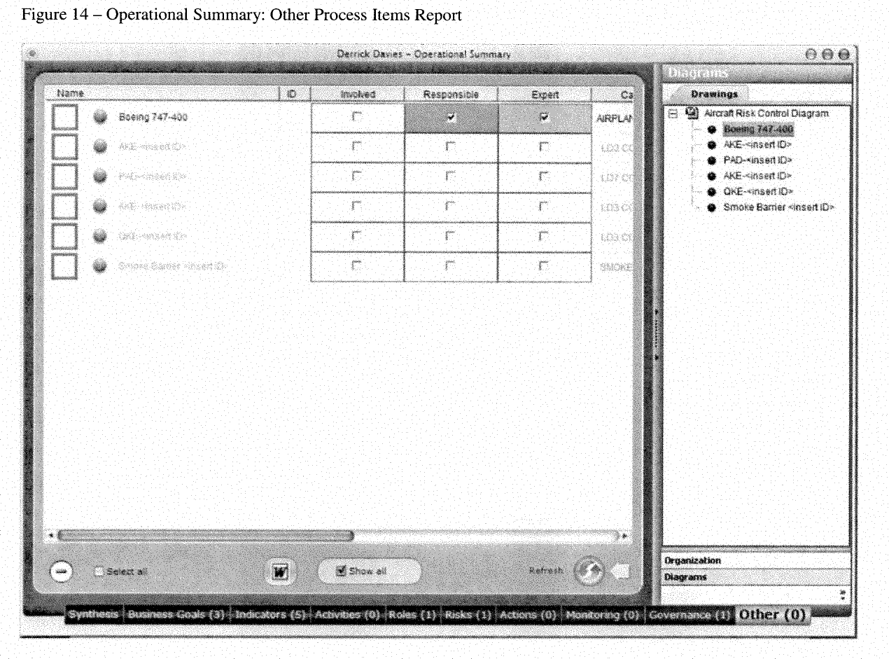

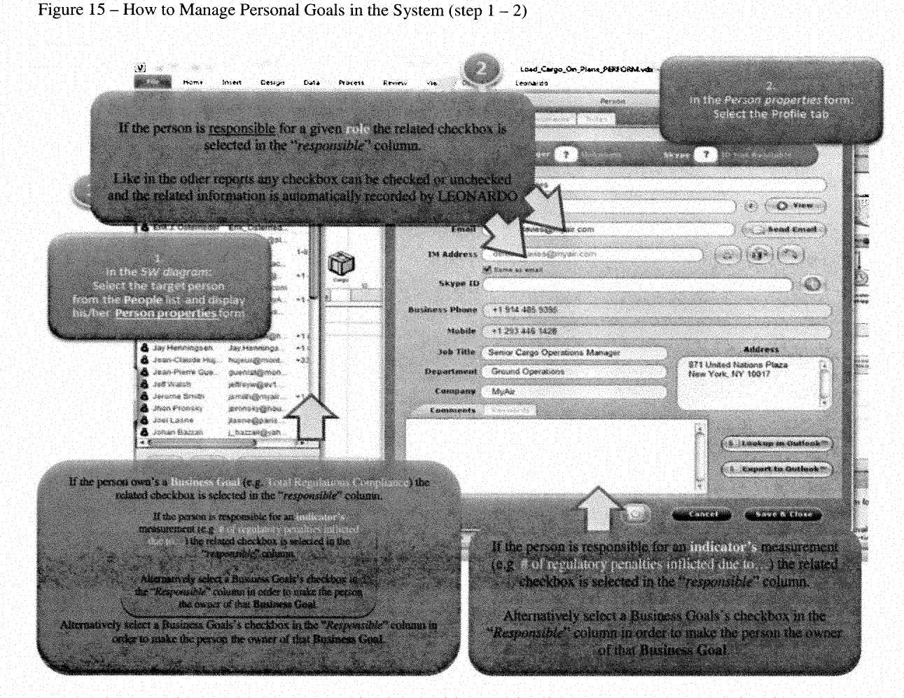

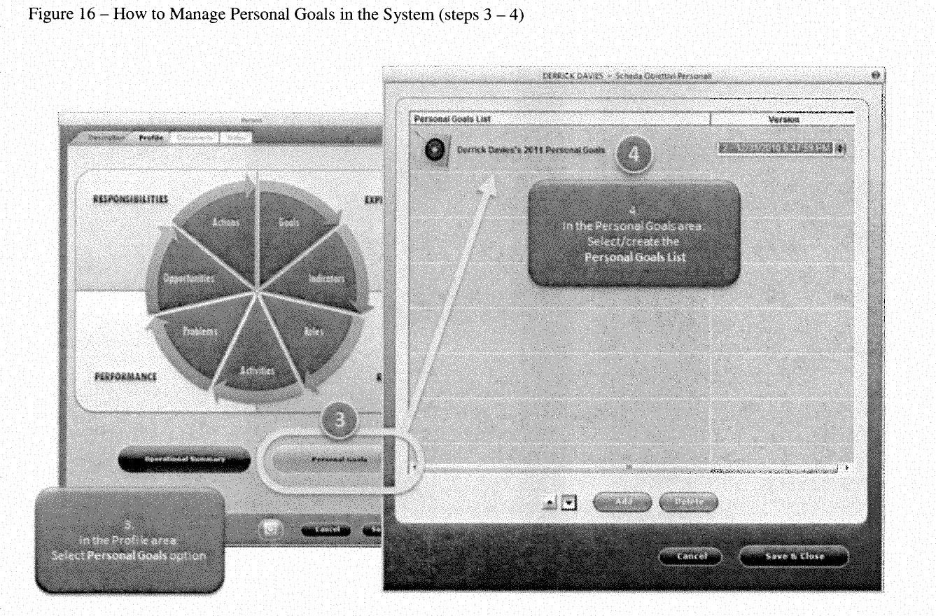

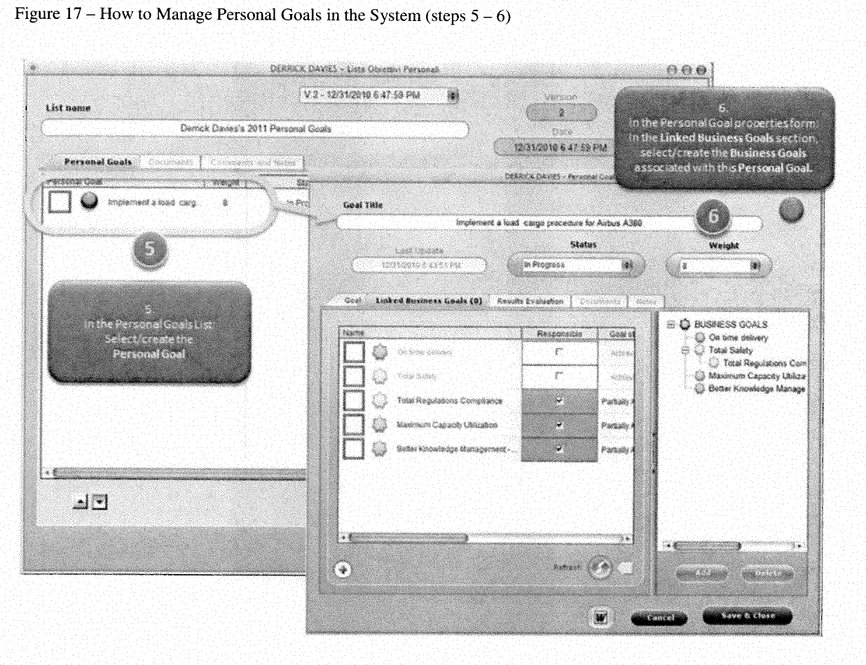

Therefore, when an employee is evaluated by his/her manager, the manager and the employee will review together the Operational Risk Summary made using the System and the parent diagram, which includes a complete picture of the employee's responsibilities within the organization (i.e. activities, roles, business goals . . . ). Based on the risk-related information recorded using the System throughout the year, they can verify together why things went wrong and what was done on both sides. These Operational Risk Summaries include information on the employee's given responsibilities, experience, performance, and risks involved in the project. In particular, the manager and employee can verify if risks undermining the achievement of Personal Goals and the related Business Goals were collaboratively identified and mitigated in a timely fashion. (See, e.g., FIGS. 5-14 for Operational Summary examples, and FIGS. 15-17 for Assigning Personal Goals).

The System facilitates the documentation of Personal Goals for each employee so that each employee's progress can be monitored by his manager or himself This ensures that the employee is aware of his progress throughout the life of the project and that management can properly motivate the employee toward attaining that Personal Goal.

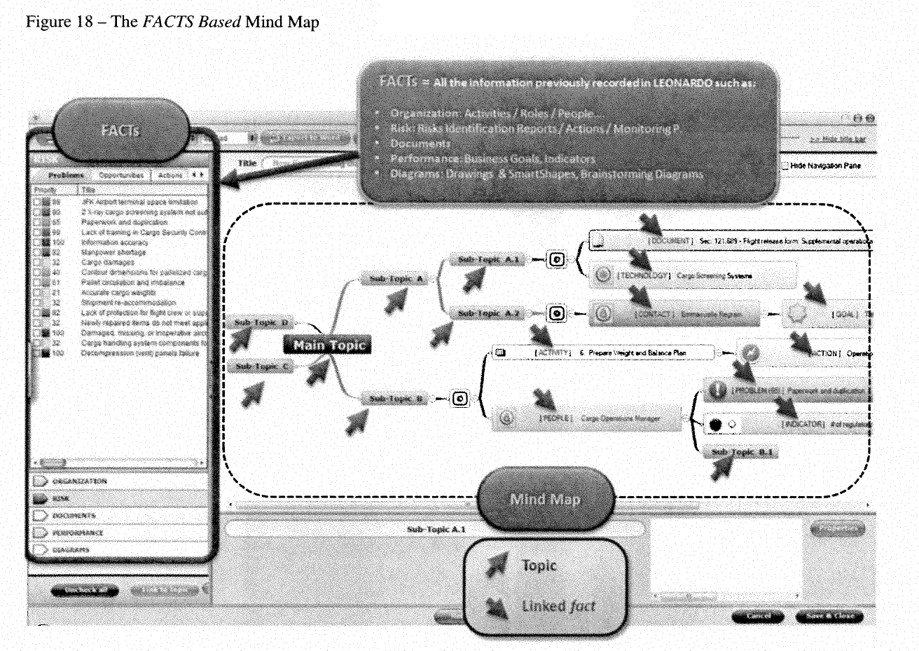

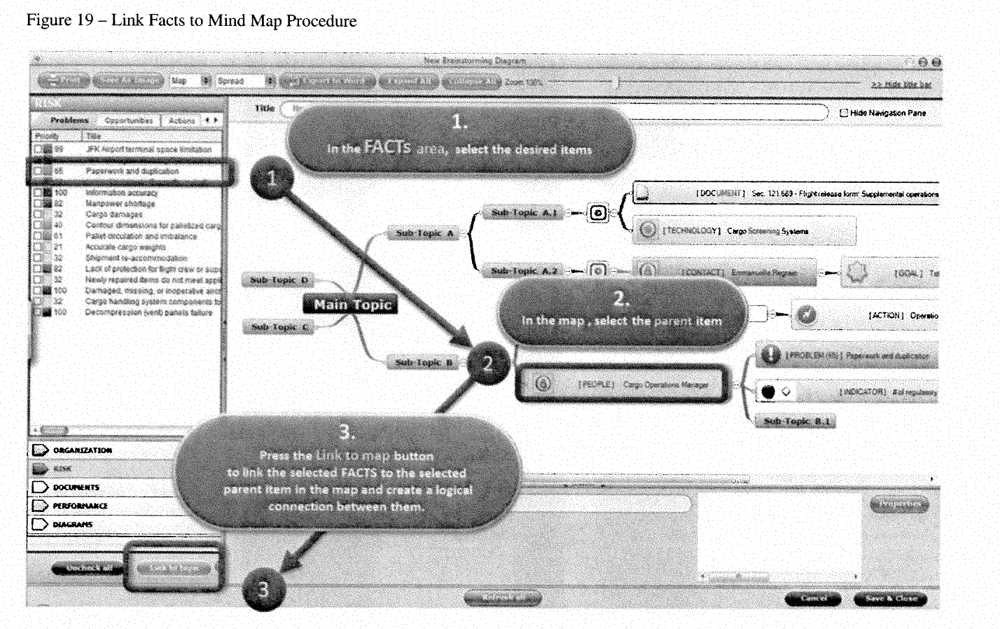

The System encourages creativity by incorporating a “mind map” style of brainstorming into the System. Such mind maps include facts already documented within the System, such as organization, risk, documents, performance, and diagrams. Using these mind maps and the facts contained within, the user can immediately engage in problem solving activities that are relevant to the problem facing the company. (See FIGS. 18-19 for examples of FACTS based mind map tool).

Additionally, The System allows the creation of “Big Picture” Reports, which are brainstorming diagrams representing, in a hierarchical fashion, all Roles and Activities contained in a parent diagram. This diagram allows a user to zoom in and out, visually verify the “global” health of the process in terms of risks, immediately identify “high risk areas” (using colors), and be able to easily access detailed information for each node.

The “Operational Readiness” Report synthesizes the risk level for any given process, whether an Organizational Unit or a Business Process. In one example embodiment, the report is represented using a fishbone diagram that helps to assess activity, human, technology, and workplace risks in order to further the achievement of Business Goals.

Given any subject matter (e.g., healthcare, construction, air cargo, etc.), related risk experts can use the System to create risk-aware smart-shapes. These smart-shapes visually represent objects (physical or abstract) logically linked to the chosen subject matter.

These risk-aware smart-shapes created by the experts contain in their properties a set of pre-defined Risk Identification Reports that may include the related control actions and monitoring procedures. The experts' knowledge about existing or potential risks is, therefore, saved for later use in these risk-aware smart-shapes. Smart-shapes simplify risk assessments and can be used even by those with less or no experience in the subject matter.

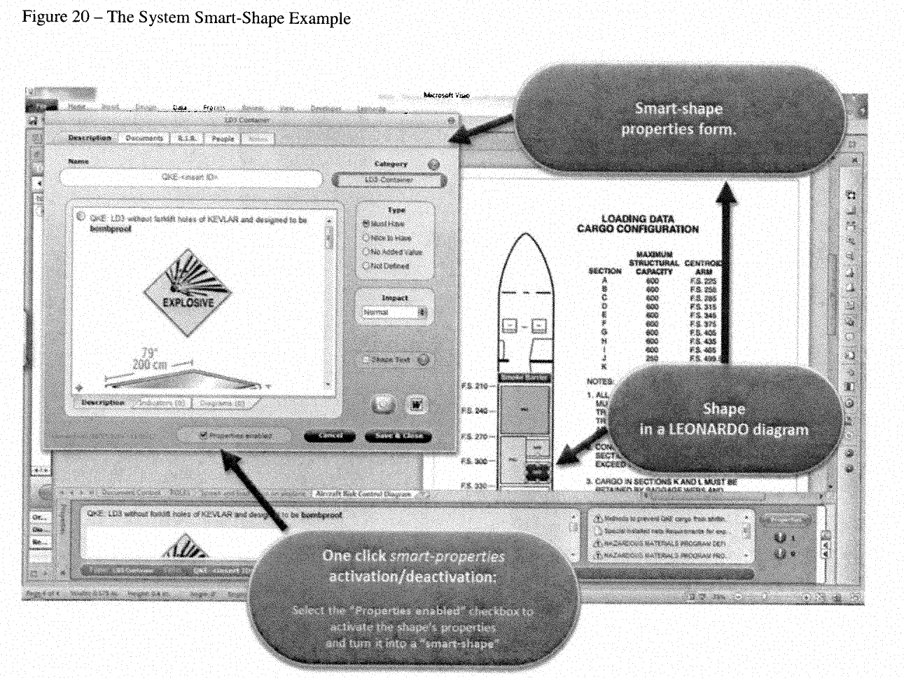

In the example of FIG. 20, the chosen subject matter is “cargo air transportation.” In this example, the experts have created different risk-aware smart-shapes including several shapes of different airplane models. Each shape's properties include, for example, airplane related knowledge such as (1) loading procedures, technical information, and manuals; (2) a list of airplane-related risks with suggested control actions and monitoring procedures; and (3) a list of people (experts) to be consulted in case help is needed. Another shape represents several different air cargo containers, or Unit Loading Devices (“ULDs”) with similar information.

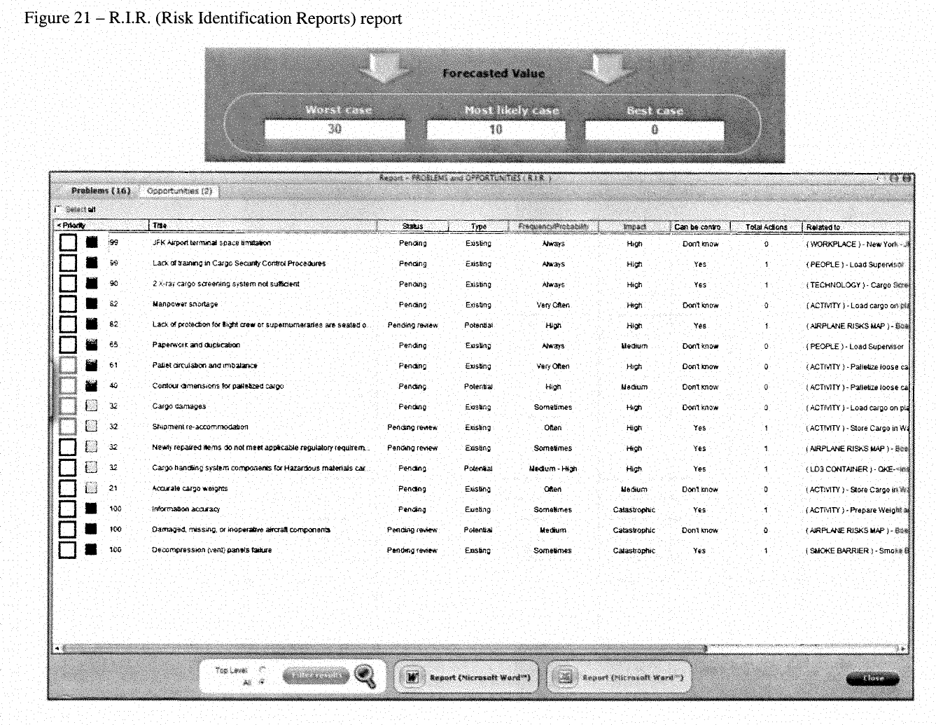

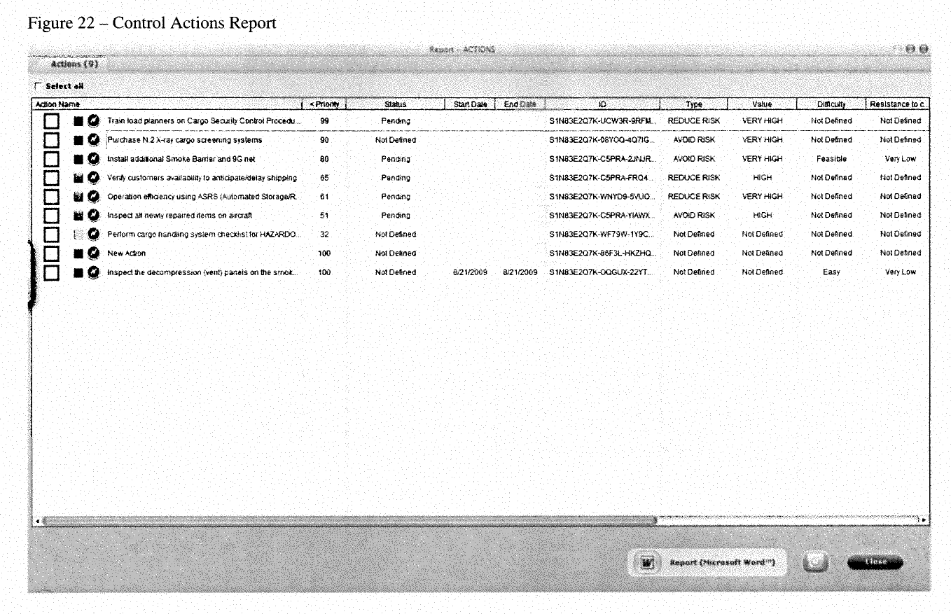

The System assists in creating visual diagrams in which to put these Smart-Shapes so that a business can visually identify the effect of the shape on the Business Goal, including any possible risks. For example, the diagram of a cargo plane shows several risks can be present. Further, the System allows the review of all risks and all control actions in a single, easy to use report. (See FIGS. 21 and 22).

In the example of FIG. 20, a user adds the desired airplane model smart-shape to the System diagram. In this example, the airplane will be loaded with a well-defined set of cargo containers of ULDs according to a specific weight and balance while considering the plane's spatial allocation.

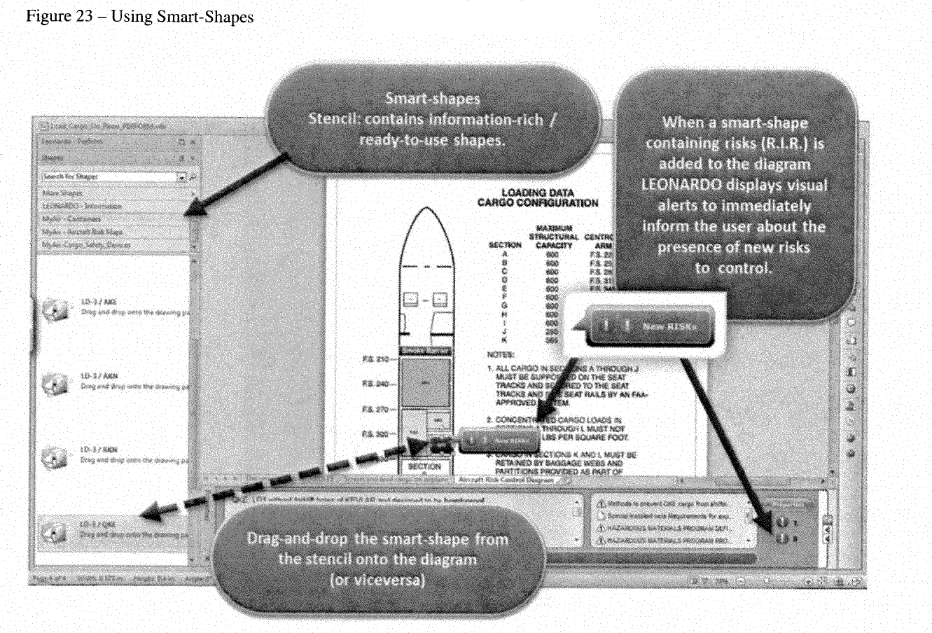

As soon as the user adds the airplane model smart-shape to the diagram, a “risk alert” message pops up to inform the user that the chosen airplane model is associated with one or more risks which he/she must review. (See FIG. 23).

Subsequently, the user adds to the diagram the various cargo container shapes to be loaded on the airplane and positions them according to the weight and balance plan. Again, for certain shapes the “risk alert” message pops up to inform the user (e.g., when the user adds the shape of a “bomb proof container” designed to carry explosives).

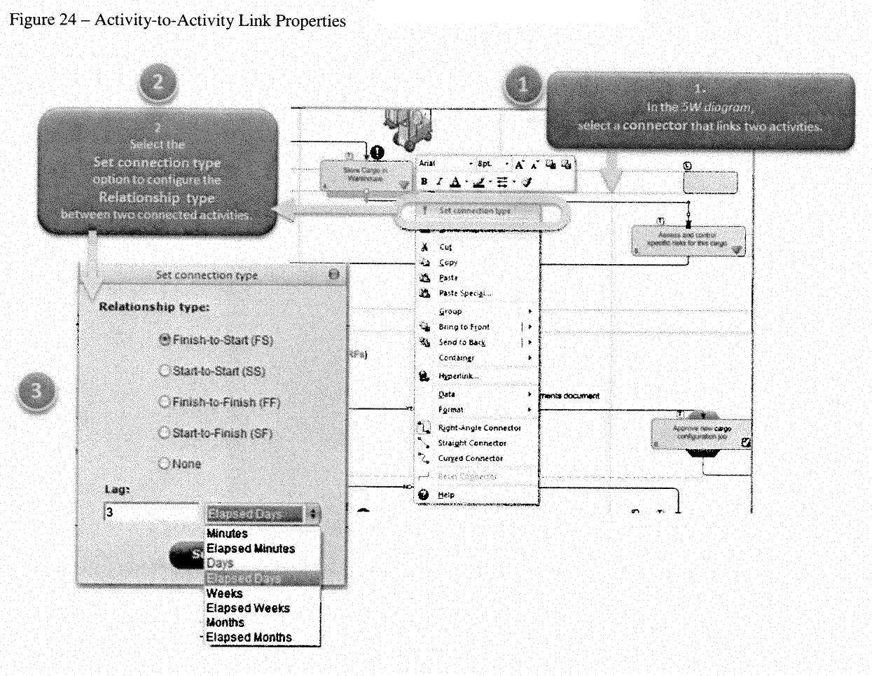

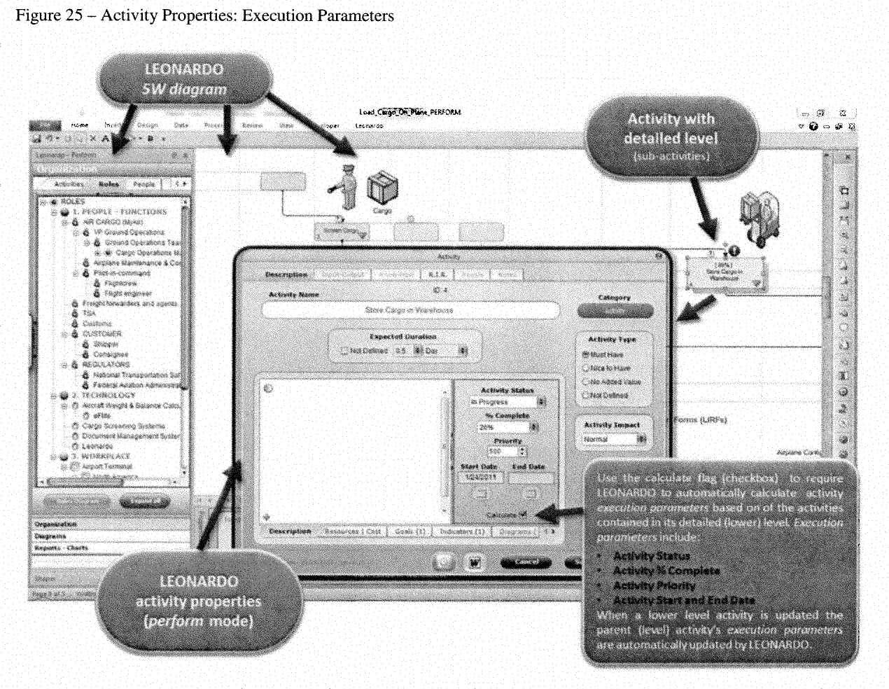

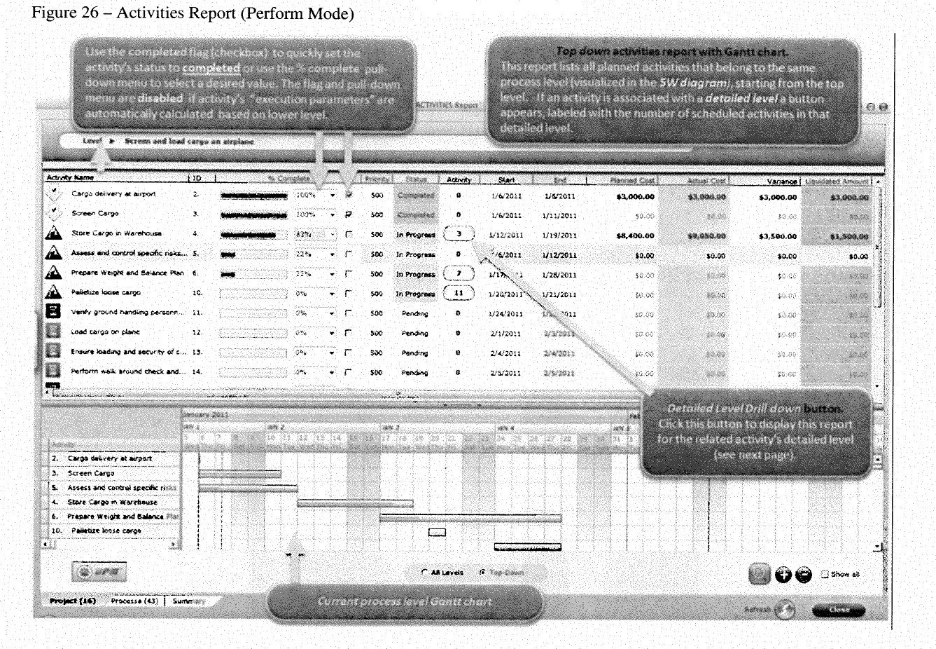

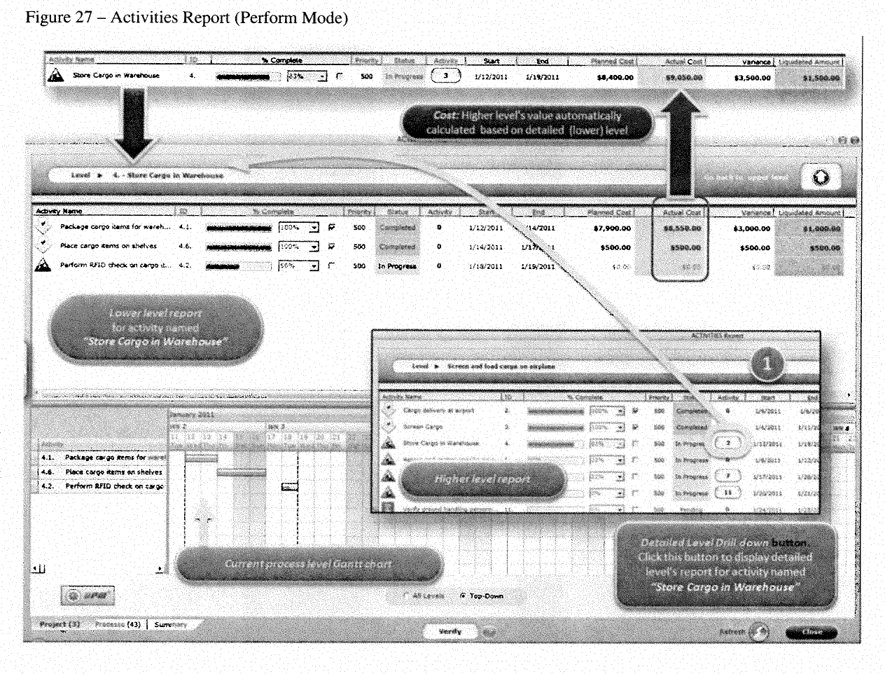

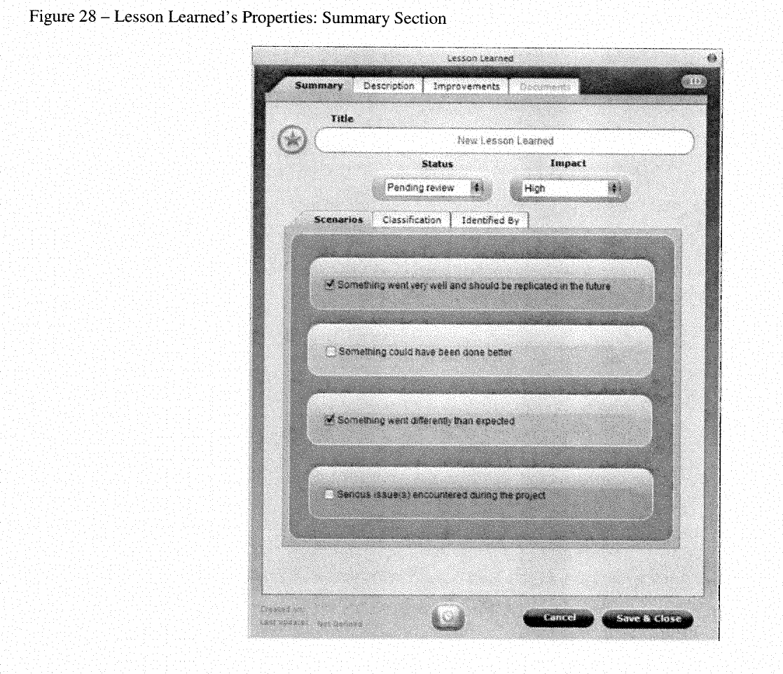

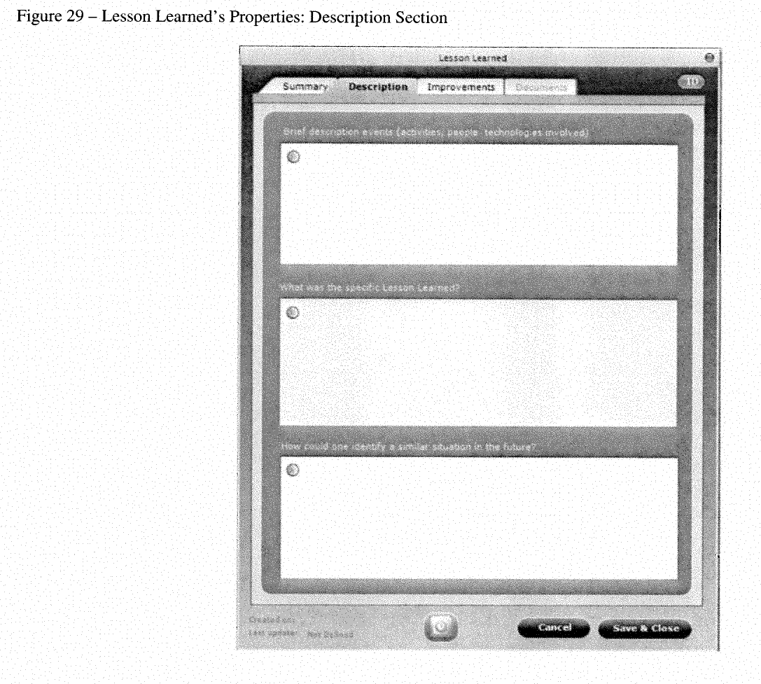

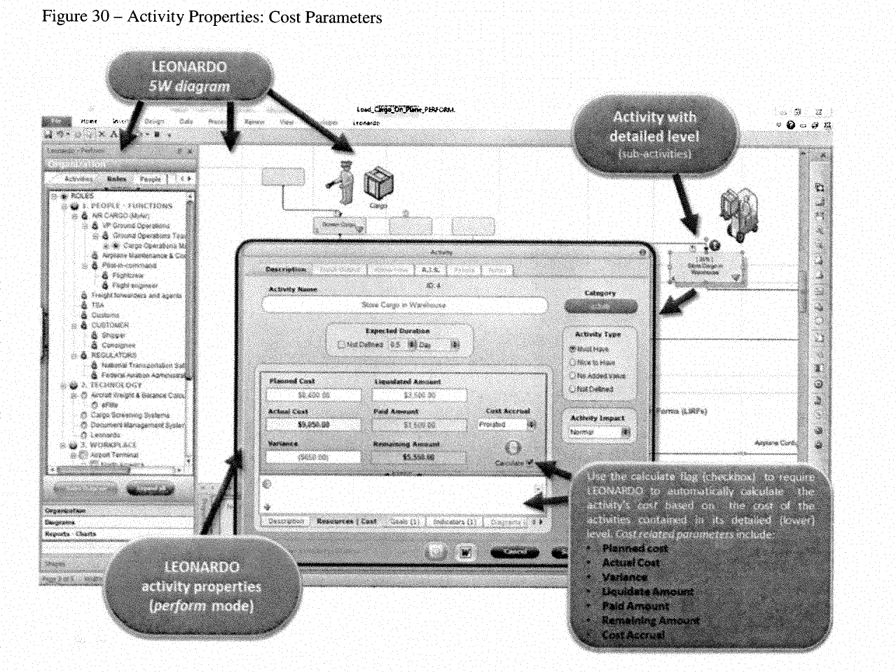

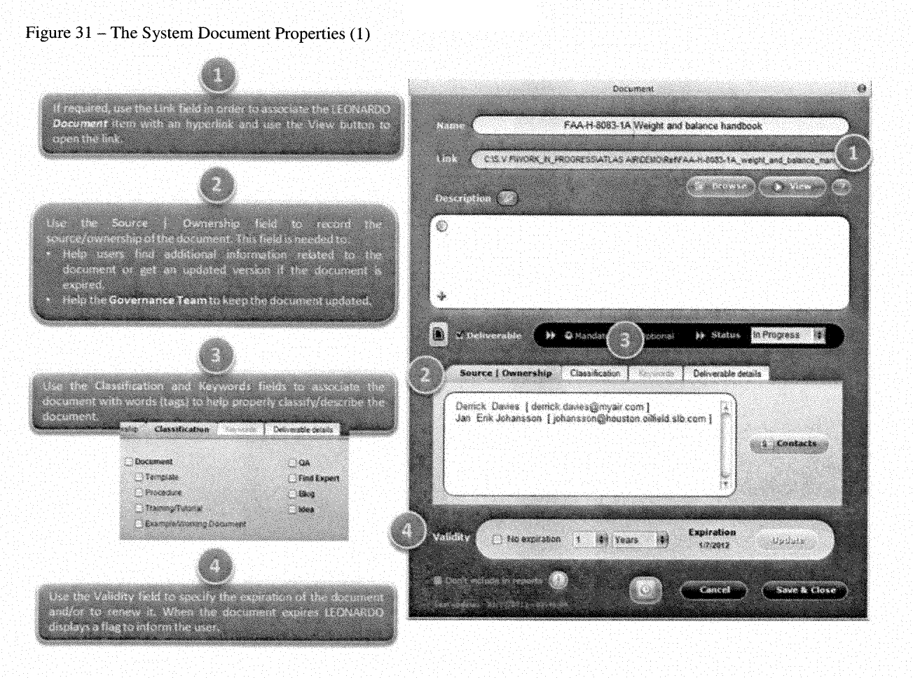

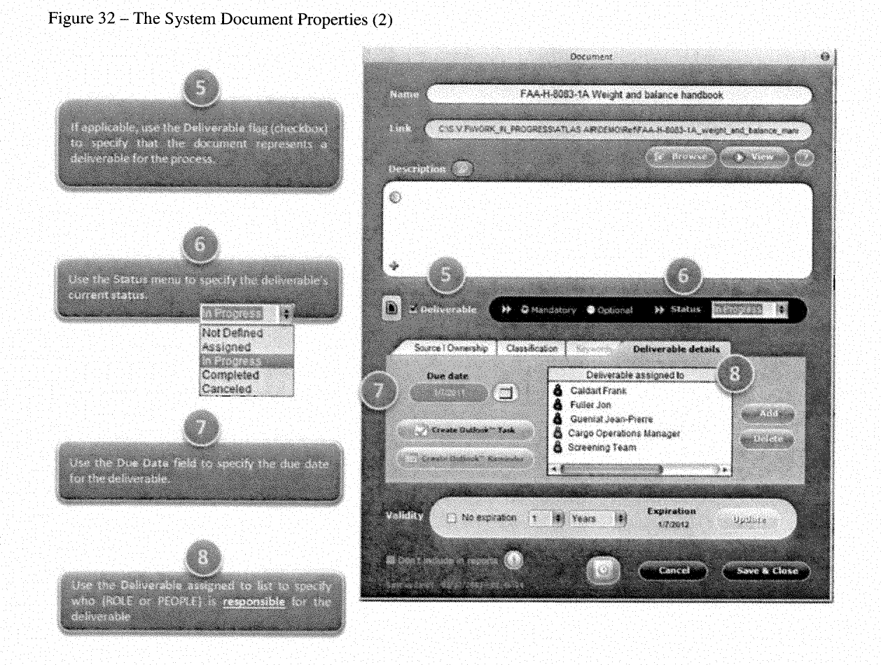

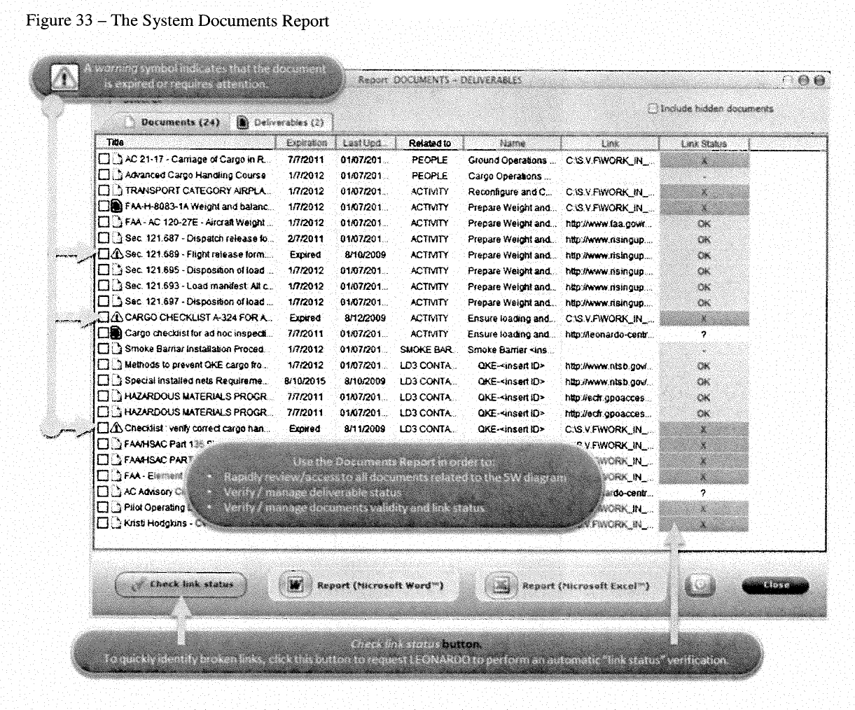

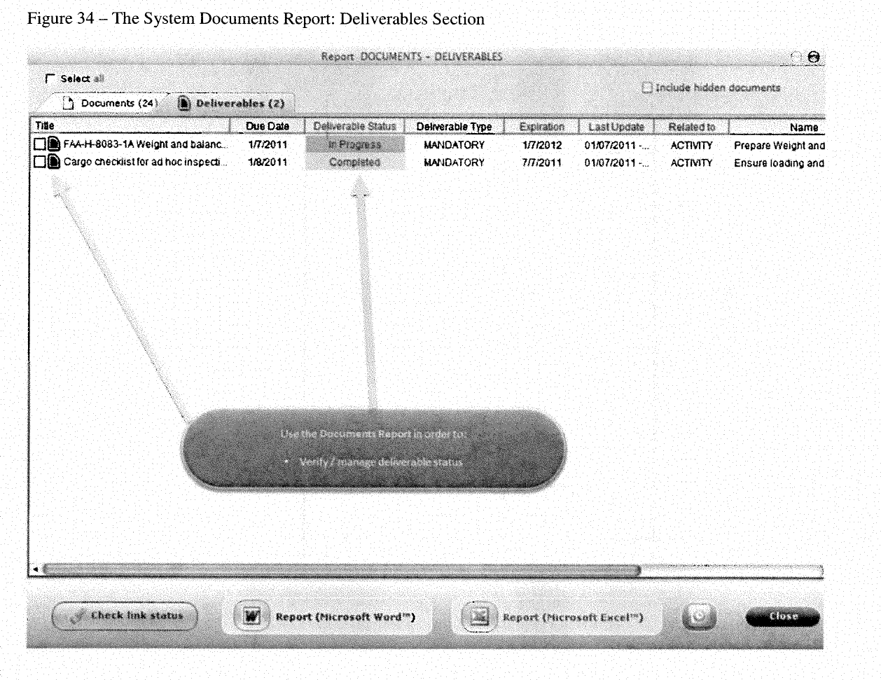

In other embodiments, the System is used to manage Process Execution. For example, the System can (1) assign activity related tasks; (2) Update and monitor the process by showing Activities' statuses, Costs, Risks, Control Actions and Monitoring Procedures, which allows the user to update, add, or remove, and responsibilities; (3) manage people; and (4) document lessons learned. At process completion, the user can use the System to prepare the process for archiving. (See also FIGS. 24-34)

Optimally, the System also allows a user to better manage documents by creating fields to be filled in, including “owner,” “expiration,” and “deliverability.” These fields allow the document to be completed timely and more easily, as well as allows the information in the document to be searched and utilized more fully.

TABLE 1
Process entity vs. Project entity relationship table

| Process entities | | Project entities |
|---|---|---|
| People-Function Role | [symbol] -- [symbol] | Work Resource (generic) |
| Technology Role | [symbol] -- [symbol] | Material Resource |
| Workplace Role | [symbol] -- [symbol] | Cost Resource |
| Person assigned to activity or role | [symbol] -- [symbol] | Work Resource (person) |
| Activity | [symbol] -- [symbol] | Task (and related sub-tasks) |
| Activity Timing (Duration, Start | [symbol] -- [symbol] | Task Timing (Duration, |
| Date, End Date . . . ) | | Start Date, End Date . . . ) |
| Activity Priority | [symbol] -- [symbol] | Task Priority |
| Role(s) involved in Activity | [symbol] -- [symbol] | Resources involved in Task |
| Activity deliverables | [symbol] -- [symbol] | Task deliverables |
| Activity to Activity connection | [symbol] -- [symbol] | Task Predecessors |
| type (see FIG. 78 - Activity-to- | | |
| Activity link properties) | | |
| Activity priority | [symbol] -- [symbol] | Task priority |

The user can use the System to develop a parent diagram where Roles are defined, the Process is documented and possibly People are assigned to specific Roles. Once a process has been visually documented in the parent diagram all relevant process entities have been defined/documented (see Table 1 above).

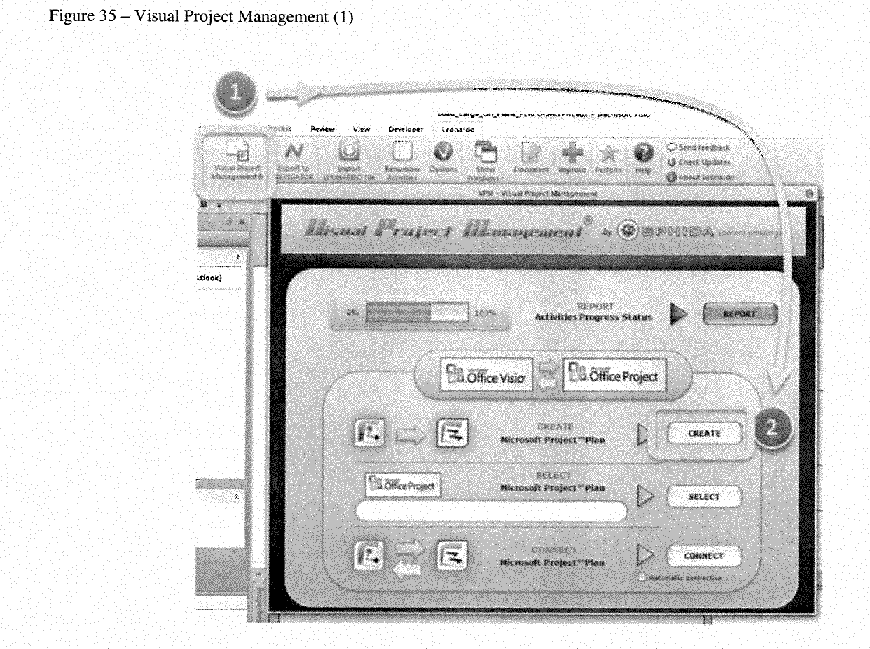

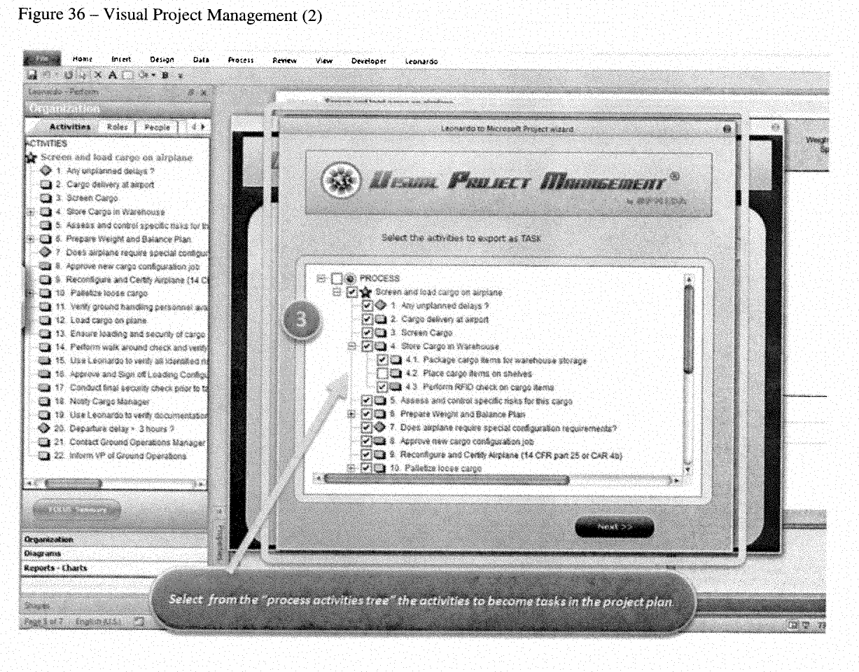

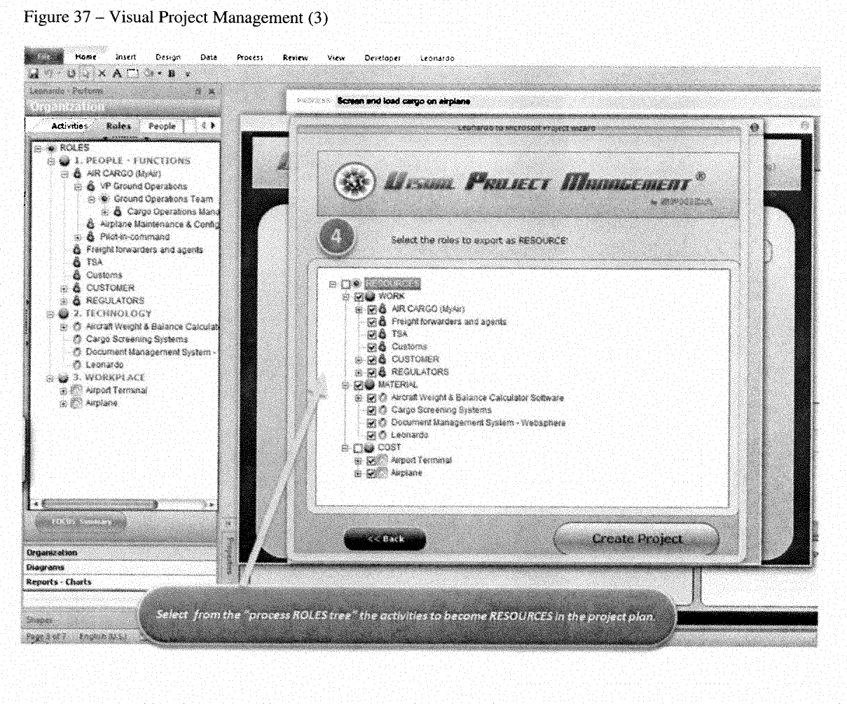

Further, the System can be used to verify that Activities have been assigned to the right roles and that, in the case of multiple Roles involved in the same activity, all the Roles involved have been visually defined in the process diagram. The System then processes the defined Activities, Roles, and People into a coherent project plan. (See, e.g., FIGS. 35-37)

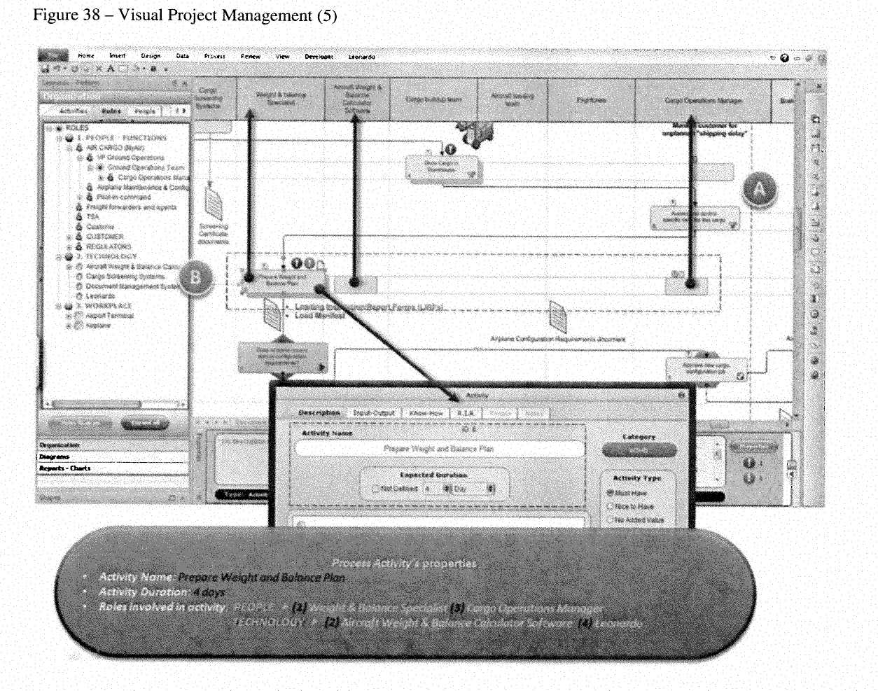

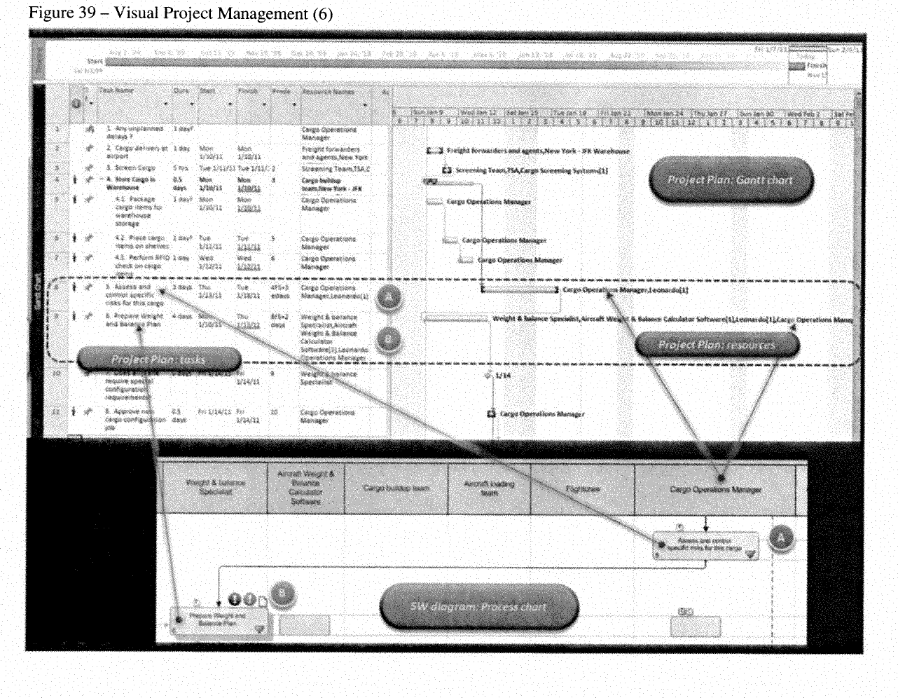

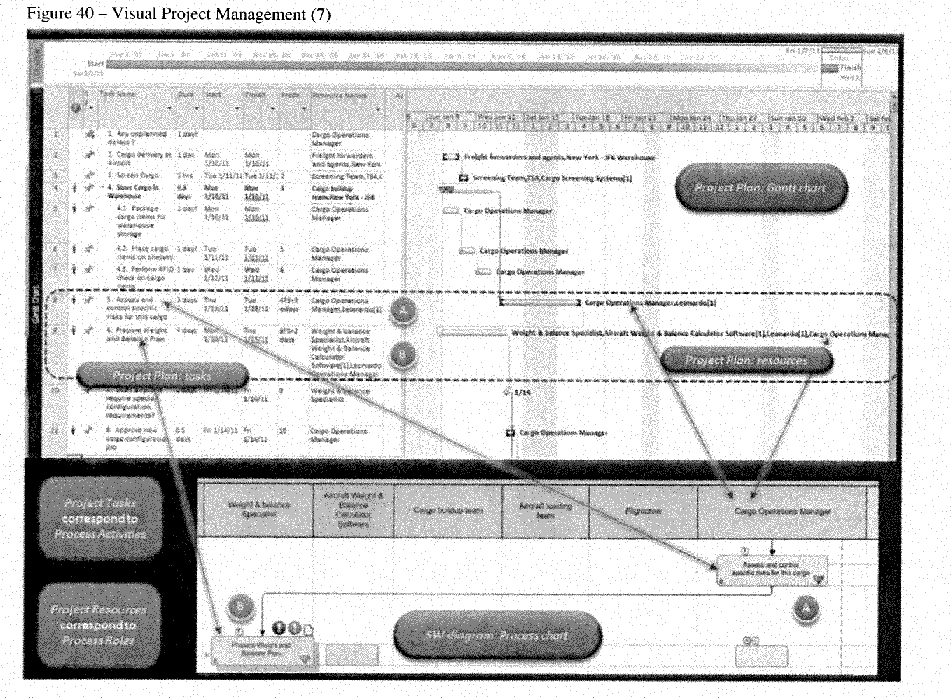

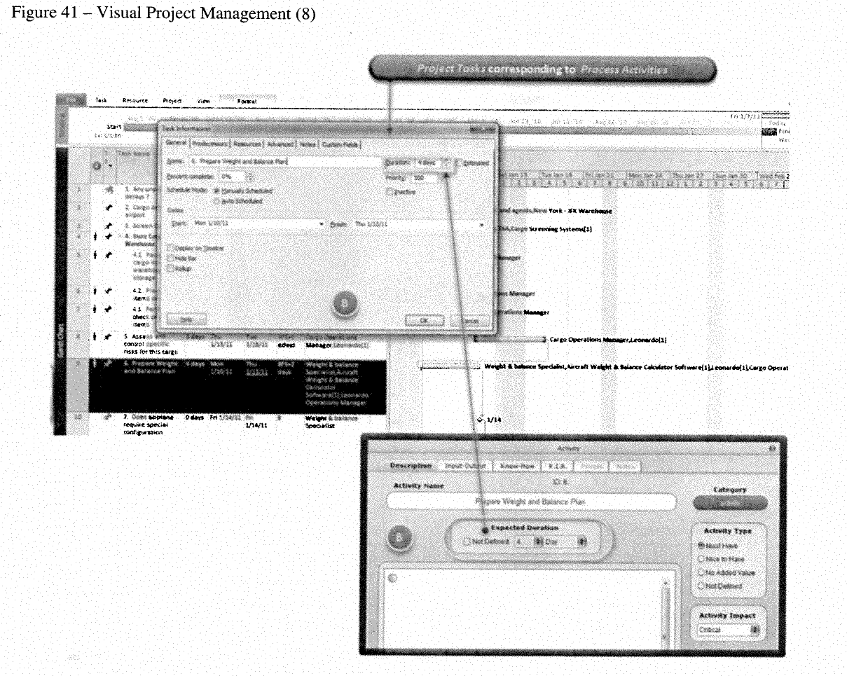

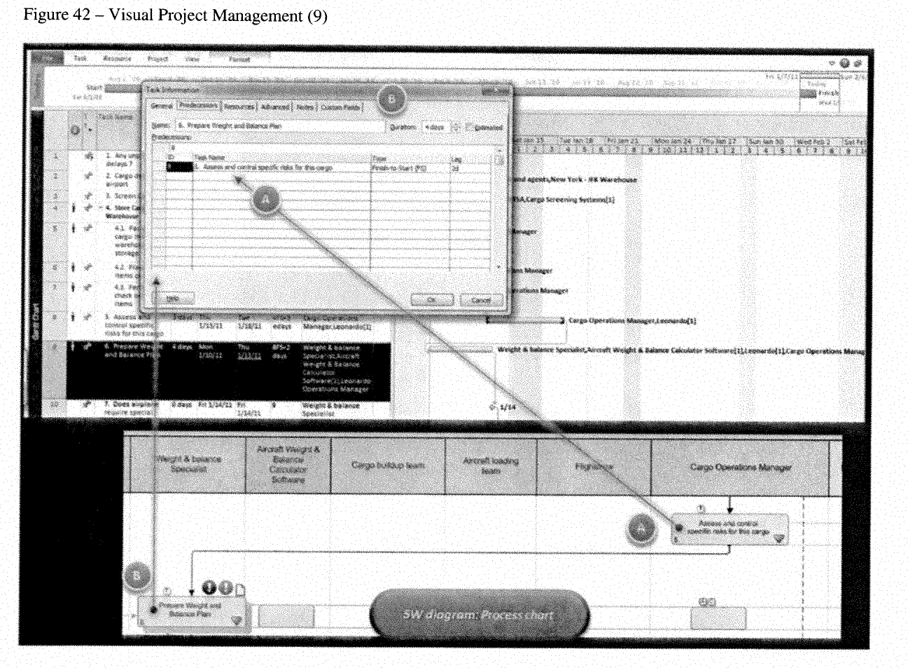

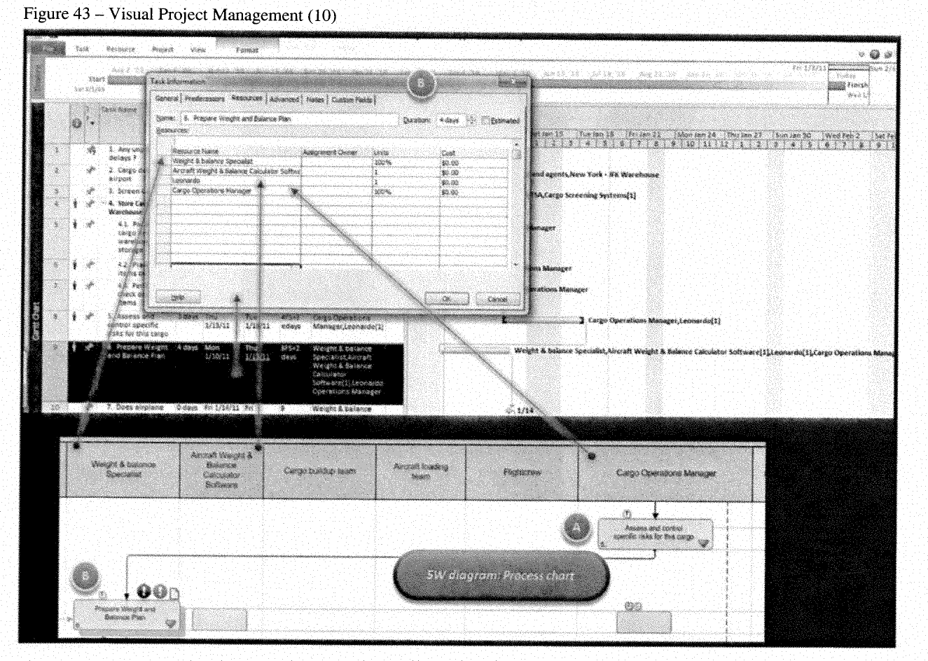

All process entity vs. project entity relationships are created by The System based on the rules described in Table 1—Process entity vs. Project entity relationship table. (See FIGS. 38-43)

Once the project plan is created by the System, a real-time connection between the process and the project plan can be established. In this case, those properties that process and project entities have in common (See Table 1—Process entity vs. Project entity relationship table) are mirrored in real-time by the System.

By combining the information managed in the project plan and the related process information managed in the “connected” parent diagram, a project manager (or project member) is able to visually document, organize and use a wide range of vital information related to the project such as tasks, resources, costs, know-how, risks, documents. and deliverables, people, business goals, and indicators. All of this is done through the System.

The System enables a user to establish a logical association between a user's tasks, reminders, and emails, and one or many KPUs, or with KPU logical entities which represent the business context. This allows the System's user to review in a glance all tasks, reminders, or emails logically associated with any given KPU or KPU logical entity.

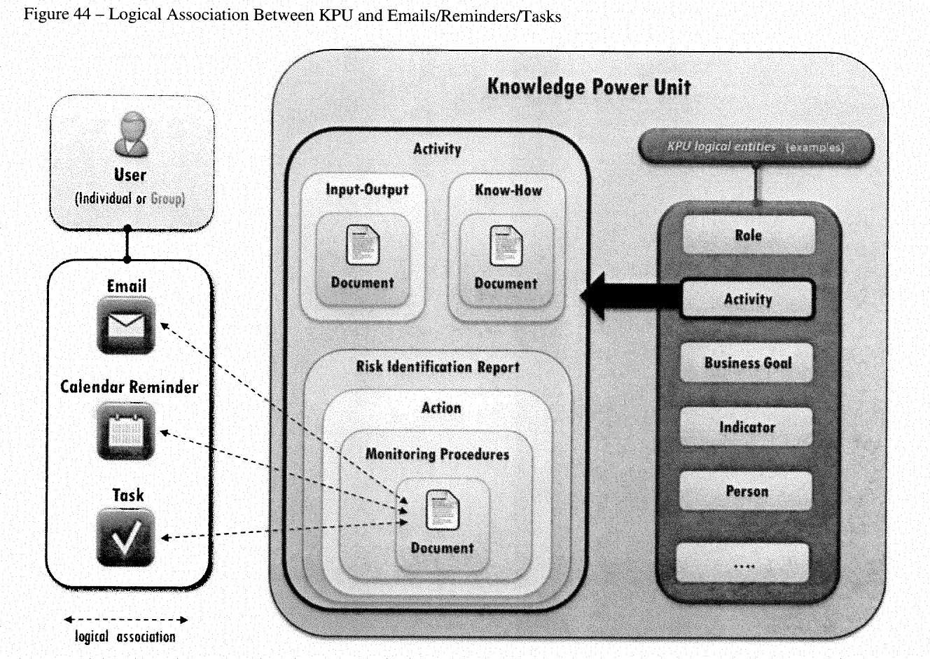

FIG. 44 provides an example in which a document (i.e., a KPU logical entity) is associated with a certain number of emails, reminders, and tasks. In this case, the document represents the business context.

In this example, the Monitoring Procedure containing the associated document represents the extended business context, because the document is logically contained in the Monitoring Procedure, which is logically contained in the Action, which is logically contained in the Risk Identification Report, and so forth. (See FIG. 44).

Therefore, once the document is logically associated with, for example, an email, the document's extended business contexts (e.g., Monitoring Procedure, Action, Risk Identification Report, Activity, KPU, etc.) are also automatically associated by the System with the same email.

Later, when a user requires the System to display all tasks, reminders and emails associated with an Activity, the System displays not only the items originally associated with the Activity, but also the items originally associated with its children logical entities. If a task, reminder, or email associated by a user with a certain KPU is then shared with other users, these users will also be able to see the same association when accessing the same KPU.

The System can successfully create communities of collaboration using a reference KPU as the starting point to define a common glossary, a set of common processes, and a bulk of reference knowledge to get the community started. In time, the initial KPU based content will be enriched with the contributions of documents and/or new KPUs. This interconnectivity allows a user to search and reuse content among all shared KPUs, which makes management of these KPUs faster and easier.

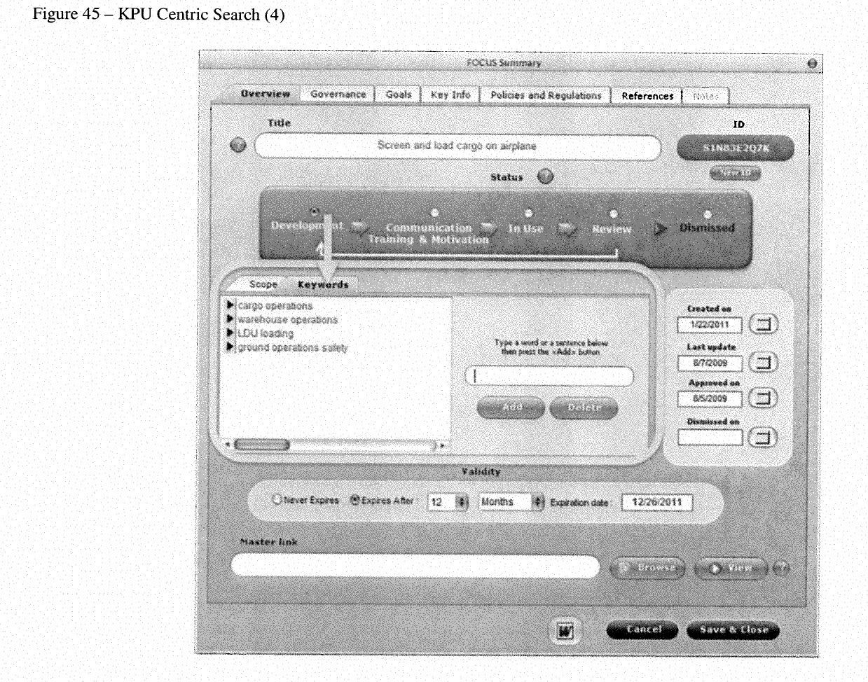

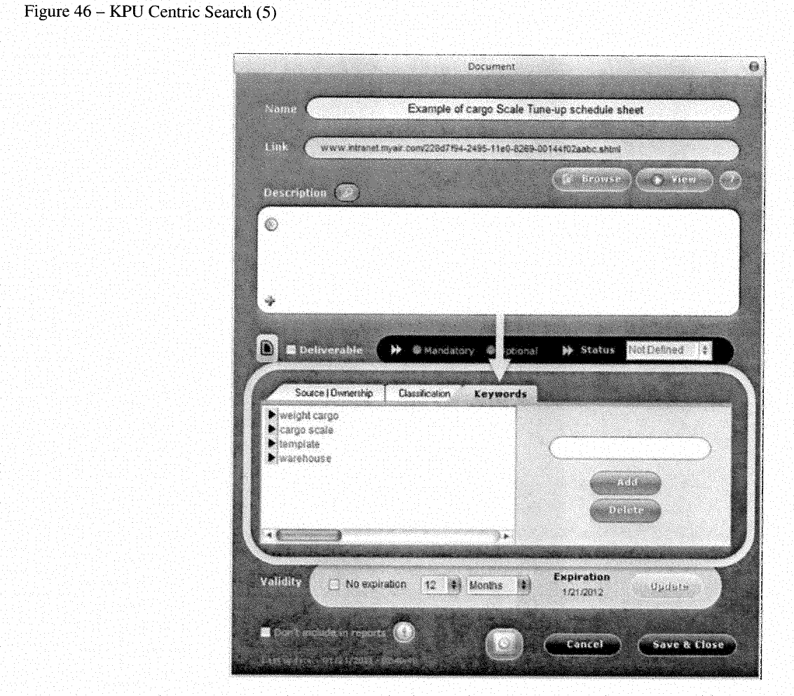

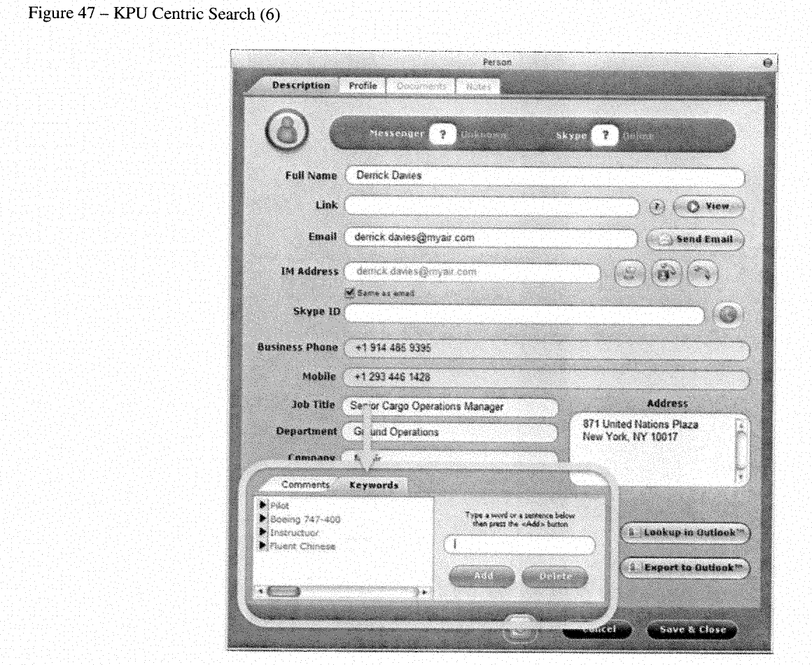

Moreover, the System's search engine automatically indexes each KPU and its related content. In addition, to increase a search result's accuracy, the System allows a user to manually tag each KPU with one or more keyword, or to tag logical entities like Business Goals or Indicators. (See, e.g., FIGS. 45-47).

In addition to user assigned tags, the System search engine uses a number of rules to correctly rank search results. These rules take advantage of the fact that the information associated with each KPU is organized according to a well-defined logical structure in which each field has a well-known meaning.

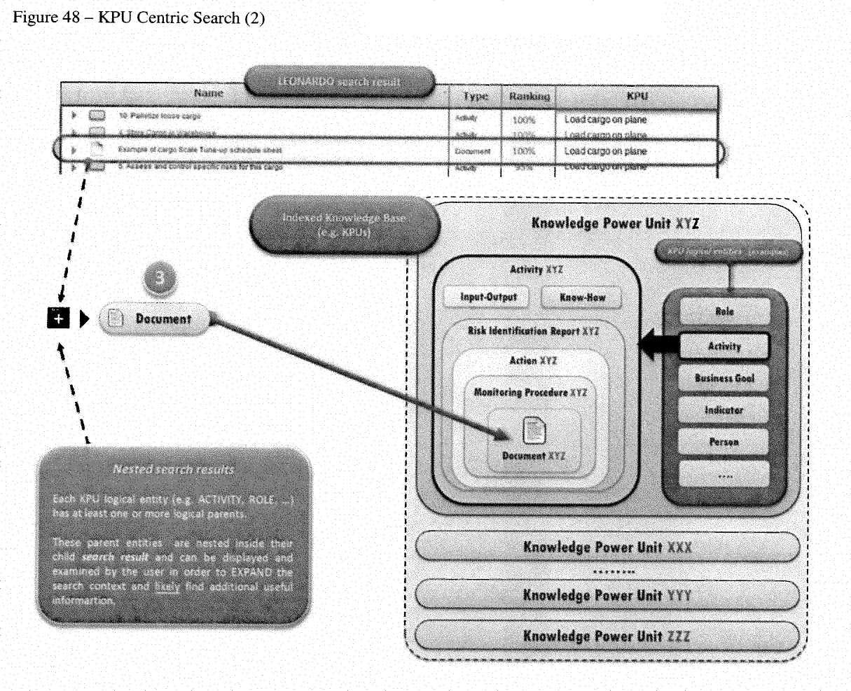

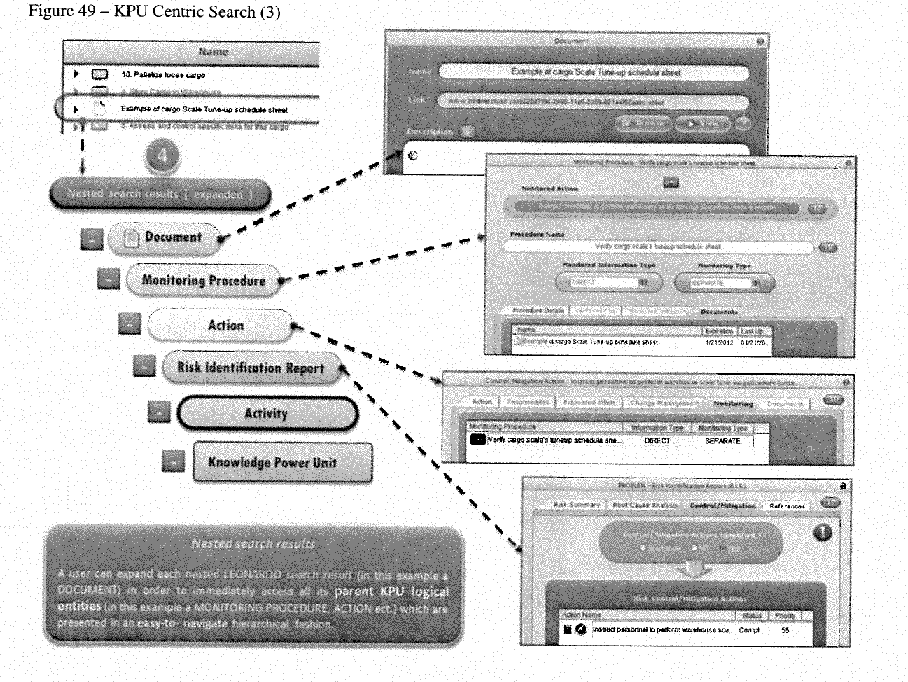

When a KPU or a KPU logical entity is listed as a search result, the search result can be expanded by the user in order to view its children KPU logical entities if any (hereinafter referred to as “nested search results”). (See, e.g., FIGS. 48-49). Nested search results are also ranked by the System against the user's query. The nested search results' logical tree can be expanded in order for the user to rapidly identify interesting information. The user can open the properties form for each child KPU level entity in the nested search results tree. (See, e.g., FIG. 49). Also, each child KPU level entity's properties can be viewed as a tree structure where a user can view the individual properties of each node.

### The Methodology Cycle

A Methodology Cycle (“the Cycle”) is a methodology that is a key component within the Methodology Framework, and is especially useful when carried out in functional cooperation with the System described herein. The Cycle starts with the decision within an organization to engage a Methodology Team in order to address a specific business need. Within any organization such decision is taken by management that seeks to close the gap between the organization's business goals and its organizational capabilities to achieve these goals.

A Methodology Team Leader (“Facilitator”) will begin working with the organization's management to clarify and document key information in order to start the cycle.

First, the Facilitator identifies and documents who the initiative's Executive Sponsor is within the organization. This person is the contact point within an organization that can make necessary decisions on behalf of the organization.

The Facilitator is responsible for planning and leading the effort to implement the Methodology Cycle within the process(es)/area(s) indicated by the Executive Sponsor. In some embodiments, the Facilitator must be a certified expert in the Methodology (in theory, practice, or both). A Methodology Business Analyst can also be assigned to the organization. Optimally, the Analyst will be an expert in using the System's many functions.

Once engaged by the Sponsor, the Methodology Cycle creates or updates a KPU to capture key engagement information required by the Methodology.

To begin, the Team Leader adds the following people to the People list of the KPU: (1) Sponsor name and contacts, (2) Team Leader name and contacts, and (3) Team Members names and contacts. In one embodiment, the Team Leader can use the Manage Team Form to capture team related information.

At the end of the Team Engagement phase, the following relevant information is stored in the System Workspace: (1) Mission, (2) Vision, (3) Strategy, and (4) Values.

The next step requires the Sponsor to identify the specific business process(es) and/or organizational unit(s) that will become the focus of a dedicated Methodology Cycle. These are the process(es) and/or organizational unit(s) whose output determines the achievement of desired business goals planned by the Sponsor.

If the Sponsor is unable to clearly identify from the very beginning one or more target Organizational Units and/or target Business Processes, the Methodology Team will work with the Sponsor to capture a high level picture of the organization's business within a parent diagram (i. e., high level activities and related high level responsible roles).

Next, the Sponsor links the identified activities to one or more Business Goals that the Sponsor wants the organization to achieve. Finally, based on the activities and roles identified within the parent diagram, the Sponsor decides which Organizational Unit(s) and/or Business Processes require a dedicated Methodology Cycle.

If the Sponsor identifies multiple targets, a separate Methodology Cycle is launched for each target. This triggers the creation of a separate, dedicated KPU by the System.

Next, the Sponsor clarifies what the specific Business Goals are that the identified Organizational Unit or Business Process is supposed to achieve. For each Business Goal, the System will guide the Sponsor to provide all the relevant information required to properly describe a “business goal” according to the principles of the Methodology Methodology.

For each Business Goal, the Sponsor clarifies what the specific Results Indicators measuring the Business Goal's level of achievement are, as well as provides detailed information about each indicator. The information is then stored in a KPU.

Governance Teams (or Owners) are established by the Sponsor with help from the Methodology Team Leader to help the Sponsor and the Team Leader to more easily manage the process leading up to the Business Goal. The Methodology Team, supported by the System, will then work with the Owner (or Governance Team) to “visually” define the Operational Perimeter of the analysis.

The Operational Perimeter is a parent diagram that provides a high level description of the Organizational Unit's business or Business Process to be analyzed. This operational perimeter gives a high level visual description of the target that: (a) leads to a clear understanding of the boundaries of the analysis before the analysis is performed, (b) helps the Governance Team to validate the initial assumptions in terms of the target itself as well as business goals, and (c) helps the Sponsor decide whether a Steering Committee is required. The Methodology Team Leader will use the Operational Perimeter to verify that current Business Goals and their related indicators (i.e., results indicators) are still applicable and complete.

The Methodology Cycle adopts an innovative “holistic and process-centric” approach. A key original idea of the Methodology is to use a “process” as the central visual element to which multiple management disciplines and tools are applied at the same time. This avoids the typical independent application of the disciplines, which is the root cause of effort duplication, conflicts between initiatives, and poor or partial results.

Ultimately, this leads to a “horizontal view of the business,” taking into account the fact that, in business, goals are rarely accomplished by one organizational unit alone.

Since in today's complex and interconnected business environment almost every business context involves multiple “players,” the Methodology's “process centric,” risk-driven, horizontal approach is well poised to systematically address and resolve one of the key problems of modern organizations: lack of collaboration.

The System allows an organization to create the parent diagram, and to further evolve it in time, using it as a visual information container that enables users to capture and manage all relevant business process information throughout the entire Methodology Cycle.

Further, the System provides the organization with a single tool and a single place (the parent diagram) to capture, store, analyze, organize, combine, and make readily available all the relevant information produced throughout the entire cycle without any dispersion of critical information at each step.

In fact, the Methodology and the Governance teams use an increasingly information-rich parent diagram (with its core element being the business process) to document and organize business-related information such as knowledge, risks, people, tasks, goals, and indicators. Every step will build upon the previous ones, leveraging the information captured during those steps.

A clear, complete and well-structured representation of the business allows complementary initiatives to be consistent with each other and assure perfect continuity and consistency of business focus.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from the spirit or scope thereof.

1. A system for enhancing and sustaining operational efficiency, said system comprising:
an electronic processor disposed in communication with a software package that is capable of defining a plurality of management business goals; defining a plurality of result indicators and performance indicators associated with said management business goals; applying one or more electronic tools to develop and document desired business processes and to establish and refine said desired business processes; applying said electronic tools to compare current performance metrics to desired business metrics for at least one of a process, an organizational unit, or an entire organization and to compile comparison metrics associated with said current performance metrics and said desired business metrics; communicating at least one of said desired business processes, said current performance metrics, said desired business processes, and said comparison metrics to a plurality of predetermined parties; executing an organizational process in which previously known risks and evolving new risks are identified, assessed, and monitored; applying said electronic tools to a governance structure in order to review said desired business processes; comparing actual results to target results associated with said desired business processes; and ensuring said governance structure recognizes and identifies for reward at least one of persons, said organizational unit, and said entire organization based on comparing said actual results to said target results.

2. The system of claim 1, wherein said software package is capable of identifying at least one business activity required to satisfy an achievement condition associated with said management business goals based on a correlation of said business activity with said result indicators; and selecting personnel responsible for achievement of said management business goals based on a correlation of said business activity with said personnel.

3. The system of claim 1, wherein said software package is capable of identifying and documenting at least one operational risk.

4. The system of claim 3, wherein said software package is capable of defining and classifying said at least one operational risk.

5. The system of claim 1, further comprising at least one knowledge power unit, wherein said knowledge power unit comprises a tree-like logical structure that is capable of facilitating business information organization.

6. The system of claim 5, wherein said knowledge power unit further comprises at least two tree nodes logically linked together within said tree-like logical structure.

7. The system of claim 5, wherein said knowledge power unit further comprises a plurality of default and customizable visual diagram templates.

8. The system of claim 7, wherein said plurality of default and customizable visual diagram templates further comprise a plurality of risk-aware smart shapes.

9. The system of claim 5, wherein said knowledge power unit is capable of establishing a top-down process diagram in which a plurality of logically connected activities and sub-activities are identified and translated visually in a sequence of interlinked process diagrams.

10. The system of claim 5, wherein said knowledge power unit is capable of selecting at least one operating mode from a plurality of possible operating modes, wherein said plurality of possible operating modes comprises at least one of a documentation mode, an alignment mode, and an execution mode.

11. The system of claim 5, wherein said knowledge power unit is capable of comparing identified role and responsibility information to logically connected business goal information.

12. The system of claim 5, wherein said software package is capable of allowing users to logically link emails, tasks, and calendar items to individual knowledge power unit logical entities; and automatically extending user created associations to parent entities.

13. The system of claim 1, wherein said software package is capable of associating a process logical entity with at least one project logical entity; creating a project plan from a process diagram; and performing bidirectional updates between said project plan and said process diagram.

14. The system of claim 1, wherein said software package is capable of assigning activity related tasks; updating and monitoring an ongoing process by showing at least one of an activity status, timing, costs, deliverables status, risks, control actions, and monitoring procedures allowing users to update, add, or remove; managing people to whom said activity related tasks are assigned; and documenting information relating to aspects of said ongoing process.

15. The system of claim 14, wherein said software package is capable of linking said management business goals to at least one predefined activity.

16. The system of claim 15, wherein said software package is capable of determining parties responsible for said management business goals.

17. The system of claim 16, wherein said software package is capable of identifying operational risks defined in said knowledge power unit that will affect execution of said management business goals.

18. The system of claim 17, wherein said software package is capable of identifying said control actions useful for mitigating said operational risks.

19. The system of claim 18, wherein said software package is capable of identifying said monitoring procedures relating to said operational risks and said control actions.

20. The system of claim 5, wherein said software package is capable of determining knowledge power unit risks; documenting said knowledge power unit risks in an associated risk identification report; and assigning an alphanumeric value to each of said knowledge power unit risks in order to prioritize said knowledge power unit risks for a user.

21. The system of claim 13, wherein said software package is capable of identifying and comparing said control actions in order to prioritize factors most relevant to successful completion of said management business goals.

22. The system of claim 21, wherein said software package is capable of calculating a difficulty factor associated with implementing said control action, and an expected resistance factor associated with a change made as a result of said control action.

23. The system of claim 5, wherein said software package is capable of searching data stored within said knowledge power unit; prioritizing search results; and organizing and displaying said search results.
